(19) United States
(12) Patent Application Publication
(10) Pub. No.: US 2005/0074177 A1
(43) Pub. Date: Apr. 7, 2005

(54) Video coding method

(76) Inventors: Daijiro Ichimura, Tokyo (JP); Yoshimasa Honda, Kamakura-shi (JP)

Correspondence Address: NATH & ASSOCIATES, PLLC;Sixth Floor, 1030 15th Street, N.W., Washington, DC, 20005, US

(21) Appl. No.: 10/950,913

(22) Filed: Sep. 28, 2004

(30) Foreign Application Priority Data
Oct. 3, 2003 (JP) 2003-346272

(51) Int. Cl. G06K 9/36

(52) U.S. Cl. 382/240

(57) ABSTRACT

A video coding method enabling implementation of resolution scalability while improving the coding efficiency. In the method, a band dividing section 104 performs band division on a high-resolution original image to generate a middle-resolution image, horizontal component, vertical component and diagonal component. The horizontal component is subjected to the DCT processing in horizontal layer DCT section 124, and then subjected to the bit-plane VLC processing in horizontal layer bit-plane VLC section 126. The vertical component is subjected to the DCT processing in vertical layer DCT section 130, and then subjected to the bit-plane VLC processing in vertical layer bit-plane VLC section 132. The diagonal component is subjected to the DCT processing in diagonal layer DCT section 136, and then subjected to the bit-plane VLC processing in diagonal layer bit-plane VLC section 138. In scanning, a scanning order is determined in consideration of bias in the distribution of DCT coefficients for each band component.

### BACKGROUND OF THE INVENTION

1. Field of the Invention

The present invention relates to a video coding method having resolution scalability.

2. Description of Related Art

Video has already been closely-linked to our lives and invaluable which causes us to enjoy visual information in various display terminals such as personal computers, mobile phones, televisions and hi-vision televisions through transmission means such as the internet, mobile-phone networks, broadcast waves and storage media.

In order to transmit information to users efficiently, video signals are compressed into video streams with a smaller amount of data using video coding techniques. Recently, video stream transmission has become widespread where received video coded data is replayed sequentially, instead of replaying the video coded data after downloading all the data. However, in conventionally used video coding techniques such as H.261 standard and MPEG (Moving Picture Experts Group) standard, the amount of code used in decoding is determined uniquely after the data is once coded, and therefore, it is not possible to vary the quality of video to replay. Accordingly, in the case of providing a single video stream to two parties with different communication bands, the video data is coded twice to adapt to each of the bands and transmitted, or coded while decreasing the quality (SNR representing a ratio of an original image to an error), resolution (spatial resolution representing the number of pixels), and/or a frame rate of video in accordance with one of the communication bands with narrow characteristics.

Scalable video coding schemes have currently been proposed which have a data structure comprised of a number of layers and enable an amount of a stream to transmit to be varied if necessary even after coding, and some of the scalable video coding schemes have been standardized. In the scalable video coding schemes, image quality, resolution, frame rate and so on can be selected after video is coded. In addition, enabling selection of image quality or resolution after coding is referred to as having image quality scalability or resolution scalability, respectively.

In recent years, with sophisticated camera techniques, advanced video has appeared in various fields, and the need of the scalable video coding scheme has further increased.

For example, Japanese Laid-Open Patent Publication 2001-16583 describes a video coding apparatus with resolution scalability. The video coding apparatus enables coding of high-resolution video and low-resolution video, adds a high-region coded stream to a low-resolution video coded stream, and thereby enables decoding of the high-resolution video.

Specifically, though not shown in figures, a low pass filter extracts a low-frequency component signal from an input high-resolution image signal, and a high pass filter extracts a first high-frequency component signal. Another high pass filter extracts a second high-frequency component signal from the low-frequency component signal, and a high-region coding section encodes the first and second high-frequency component signals. The coding processing is carried out by executing processing of quantization and VLC. Meanwhile, the low-frequency component signal is encoded in a low-resolution video coding section that performs coding of low-resolution video. The coding processing is carried out by executing processing of orthogonal conversion, quantization and VLC.

By this means, the video coding apparatus is capable of performing scalable coding with two-stage resolutions on input video with high resolution.

In addition, known as a video coding technique with image quality scalability is, for example, MPEG-4 FGS (Fine Granularity Scalability). MPEG-4 FGS is one of scalable video coding schemes specified in ISO/IEC 14496-2 Amendment 2, and particularly, standardized as a coding method enabling selection of image quality of video stream with fine granularity.

A video stream coded by MPEG-4 FGS is comprised of a base layer stream and enhancement layer stream. The base layer stream is a video layer with a low band and low image quality enabling decoding thereof alone, and the enhancement layer stream is a video stream to improve the image quality of the base layer stream. MPEG-4 FGS adopts a multilayered-coded layer structure and coding processing called bit-plane VLC (Variable Length Coding) used in enhancement layer, thereby enables the amount of code to transmit to be controlled on a frame (a screen or an image) basis, and is capable of responding to a transmission rate and image quality with high flexibility. In addition, bit-plane VLC will be described specifically later.

FIG. 1 is a block diagram illustrating a basic configuration of a video coding apparatus to which MPEG-4 FGS is applied.

In video coding apparatus 10, video input section 12 receives as its input a video signal (original image) on a frame (screen) basis to provide to base layer coding section 14 and differential section 20.

Base layer coding section 14 performs MPEG coding on the original image obtained from video input section 12, and generates a base layer stream to provide to base layer output section 16 and base layer decoding section 18. Base layer output section 16 outputs the base layer stream obtained from base layer coding section 14 to the outside of video coding apparatus 10. Meanwhile, base layer decoding section 18 decodes the base layer stream obtained from base layer coding section 14 to provide to differential section 20.

Differential section 20 calculates a difference between the original image obtained from video input section 12 and a decoded image obtained from base layer decoding section 18, and provides a differential image to enhancement layer DCT section 22. Enhancement layer DCT section 22 performs DCT (Discrete Cosine Transform) on the differential image obtained from differential section 20 on an eight-by-eight pixel block basis to generate DCT coefficients, and provides the coefficients to enhancement layer bit-plane VLC section 24. Enhancement layer bit-plane VLC section 24 performs bit-plane VLC processing on the DCT coefficients obtained from enhancement layer DCT section 22, and generates an enhancement layer stream to provide to enhancement layer output section 26. Enhancement layer output section 26 outputs the enhancement layer stream obtained from enhancement layer bit-plane VLC section 24 to the outside of video coding apparatus 10.

However, in the video coding apparatus as described in the above-mentioned patent publication, it is possible to perform scalable coding with two-stage resolutions on input video of high resolution, but processing of quantization and VLC is simply used as coding processing of high-region component, and any consideration is not given to coding efficiency. Therefore, with increases in amount of data to process, it has strongly been desired generating with high efficiency video streams enabling selection of resolution.

In MPEG-4 FGS, as described above, image quality can be selected after coding the video, but resolution cannot be selected. Therefore, it is highly desired to achieve a video coding method that enables selection of both the resolution and image quality and that has high coding efficiency.

### SUMMARY OF THE INVENTION

It is an object of the present invention to provide a video coding method enabling implementation of resolution scalability, while improving the coding efficiency.

It is a subject matter of the present invention performing band division on an original image (first-resolution image) with high resolution to generate a low-frequency component (second-resolution image component) and other sub-band components (horizontal component, vertical component and diagonal component), subjecting each sub-band component to DCT processing and coding processing (for example, bit-plane VLC), and thereby generating a video stream enabling the resolution to be selected after coding with high efficiency.

According to an aspect of the invention, a video coding method comprises a band dividing step of dividing a first-resolution image with a first resolution into a second-resolution image component with a second resolution lower than the first resolution and at least one of sub-band components including a horizontal component, a vertical component and a diagonal component, a DCT step of performing DCT (Discrete Cosine Transform) processing on the divided sub-band component, and a coding step of coding the sub-band component subjected to the DCT processing using a scanning method corresponding to a statistical result of the DCT processing associated with each of the sub-band components.

According to another aspect of the invention, a video coding apparatus comprises an input section that inputs a first-resolution image with a first resolution, a band dividing section that divides the input first-resolution image into a second-resolution image component with a second resolution lower than the first resolution and each of sub-band components including a horizontal component, a vertical component and a diagonal component, a DCT section that performs DCT processing on the divided each sub-band component, and a bit-plane VLC section that performs bit-plane VLC processing on the each sub-band component subjected to the DCT processing in a respective different scanning order, using a scanning method corresponding to a statistical result of the DCT processing associated with the each sub-band component.

According to still another aspect of the present invention, a video coding apparatus comprises an input section that inputs a first-resolution image with a first resolution, a band dividing section that divides the input first-resolution image into a second-resolution image component with a second resolution lower than the first resolution and each of sub-band components including a horizontal component, a vertical component and a diagonal component, a DCT section that performs DCT processing on the divided each sub-band component, a quantization section that quantizes the each sub-band component subjected to the DCT processing, and a VLC section that performs VLC processing on the quantized each sub-band component using a scanning method corresponding to a statistical result of the DCT processing associated with the each sub-band component.

### BRIEF DESCRIPTION OF THE DRAWINGS

The above and other objects and features of the invention will appear more fully hereinafter from a consideration of the following description taken in connection with the accompanying drawing wherein one example is illustrated by way of example, in which;

FIG. 1 is a block diagram illustrating a configuration of a video coding apparatus to which MPEG-4 FGS is applied;

FIG. 2 is a block diagram illustrating a configuration of a video coding apparatus to which is applied a video coding method according to Embodiment 1 of the present invention;

FIG. 3A is a view illustrating a high-resolution original image before band division;

FIG. 3B is a view illustrating each band component after band division;

FIG. 3C is a view illustrating a low-resolution image;

FIG. 4A is a graph illustrating an example of statistics of absolute values of DCT coefficients of a middle-resolution image;

FIG. 4B is a graph illustrating an example of statistics of absolute values of DCT coefficients of a horizontal component;

FIG. 4C is a graph illustrating an example of statistics of absolute values of DCT coefficients of a vertical component;

FIG. 4D is a graph illustrating an example of statistics of absolute values of DCT coefficients of a diagonal component;

FIG. 5A is a view showing an example of a scanning order of 8×8 DCT coefficients of the horizontal component;

FIG. 5B is a view showing an example of a scanning order of 8×8 DCT coefficients of the vertical component;

FIG. 5C is a view showing an example of a scanning order of 8×8 DCT coefficients of the diagonal component;

FIG. 6A is a view showing an example of a scanning order in the horizontal component;

FIG. 6B is a view showing another example of the scanning order in the horizontal component;

FIG. 6C is a view showing still another example of the scanning order in the horizontal component;

FIG. 6D is a view showing still another example of the scanning order in the horizontal component;

FIG. 6E is a view showing still another example of the scanning order in the horizontal component;

FIG. 7A is a view showing an example of a scanning order in the vertical component;

FIG. 7B is a view showing another example of the scanning order in the vertical component;

FIG. 7C is a view showing still another example of the scanning order in the vertical component;

FIG. 7D is a view showing still another example of the scanning order in the vertical component;

FIG. 7E is a view showing still another example of the scanning order in the vertical component;

FIG. 8A is a view showing an example of a scanning order in the diagonal component;

FIG. 8B is a view showing another example of the scanning order in the diagonal component;

FIG. 9A is a view showing an example of a scanning range of bit plane 1;

FIG. 9B is a view showing an example of a scanning range of bit plane 2;

FIG. 9C is a view showing an example of a scanning range of bit plane 3;

FIG. 9D is a view showing an example of a scanning range of bit plane 4;

FIG. 10 is a view as viewed from the direction parallel to the horizontal frequency axis in the graph as shown in FIG. 4B;

FIG. 11 is a flowchart illustrating an example of the operation of the video coding apparatus as shown in FIG. 2;

FIG. 12 is a flowchart illustrating an example of procedures of middle-region layer coding processing as shown in FIG. 11;

FIG. 13 is a flowchart illustrating an example of procedures of horizontal layer coding processing as shown in FIG. 11;

FIG. 14 is a flowchart illustrating an example of procedures of vertical layer coding processing as shown in FIG. 11;

FIG. 15 is a flowchart illustrating an example of procedures of diagonal layer coding processing as shown in FIG. 11;

FIG. 16 is a block diagram illustrating a configuration of a video decoding apparatus to which is applied a video decoding method according to Embodiment 1 of the present invention;

FIG. 17 is a flowchart illustrating an example of the operation of the video decoding apparatus as shown in FIG. 16;

FIG. 18 is a flowchart illustrating an example of procedures of middle-region layer decoding processing as shown in FIG. 17;

FIG. 19 is a flowchart illustrating an example of procedures of horizontal layer decoding processing as shown in FIG. 17;

FIG. 20 is a flowchart illustrating an example of procedures of vertical layer decoding processing as shown in FIG. 17;

FIG. 21 is a flowchart illustrating an example of procedures of diagonal layer decoding processing as shown in FIG. 17;

FIG. 22 is a block diagram illustrating a configuration of a video coding apparatus to which is applied a video coding method according to Embodiment 2 of the present invention;

FIG. 23A is a schematic view illustrating DCT coefficients of a horizontal component;

FIG. 23B is a schematic view illustrating DCT coefficients of a vertical component;

FIG. 23C is a schematic view illustrating DCT coefficients of a diagonal component;

FIG. 24 is a flowchart illustrating an example of the operation of the video coding apparatus as shown in FIG. 22;

FIG. 25 is a flowchart illustrating an example of procedures of high-region layer coding processing as shown in FIG. 24;

FIG. 26 is a block diagram illustrating a configuration of a video decoding apparatus to which is applied a video decoding method according to Embodiment 2 of the present invention;

FIG. 27 is a flowchart illustrating an example of the operation of the video decoding apparatus as shown in FIG. 26;

FIG. 28 is a flowchart illustrating an example of procedures of high-region layer decoding processing as shown in FIG. 27;

FIG. 29 is a block diagram illustrating a configuration of a video decoding apparatus to which is applied a video decoding method according to Embodiment 3 of the present invention;

FIG. 30 is a flowchart illustrating an example of the operation of the video decoding apparatus as shown in FIG. 29;

FIG. 31 is a block diagram illustrating a configuration of a video coding apparatus to which is applied a video coding method according to Embodiment 4 of the present invention;

FIG. 32 is a flowchart illustrating an example of the operation of middle-region layer coding processing in the video coding apparatus as shown in FIG. 31;

FIG. 33 is a flowchart illustrating an example of the operation of horizontal layer coding processing in the video coding apparatus as shown in FIG. 31;

FIG. 34 is a flowchart illustrating an example of the operation of vertical layer coding processing in the video coding apparatus as shown in FIG. 31;

FIG. 35 is a flowchart illustrating an example of the operation of diagonal layer coding processing in the video coding apparatus as shown in FIG. 31;

FIG. 36 is a block diagram illustrating a configuration of a video decoding apparatus to which is applied a video decoding method according to Embodiment 4 of the present invention;

FIG. 37 is a flowchart illustrating an example of the operation of middle-region layer decoding processing in the video decoding apparatus as shown in FIG. 36;

FIG. 38 is a flowchart illustrating an example of the operation of horizontal layer decoding processing in the video decoding apparatus as shown in FIG. 36;

FIG. 39 is a flowchart illustrating an example of the operation of vertical layer decoding processing in the video decoding apparatus as shown in FIG. 36; and

FIG. 40 is a flowchart illustrating an example of the operation of diagonal layer decoding processing in the video decoding apparatus as shown in FIG. 36.

### DETAILED DESCRIPTION OF THE PREFERRED EMBODIMENTS

Embodiments of the present invention will be specifically described below with reference to accompanying drawings. In addition, each of the Embodiments describes a case as an example of enabling selection of resolution between three stages, for example, low, middle and high.

### Embodiment 1

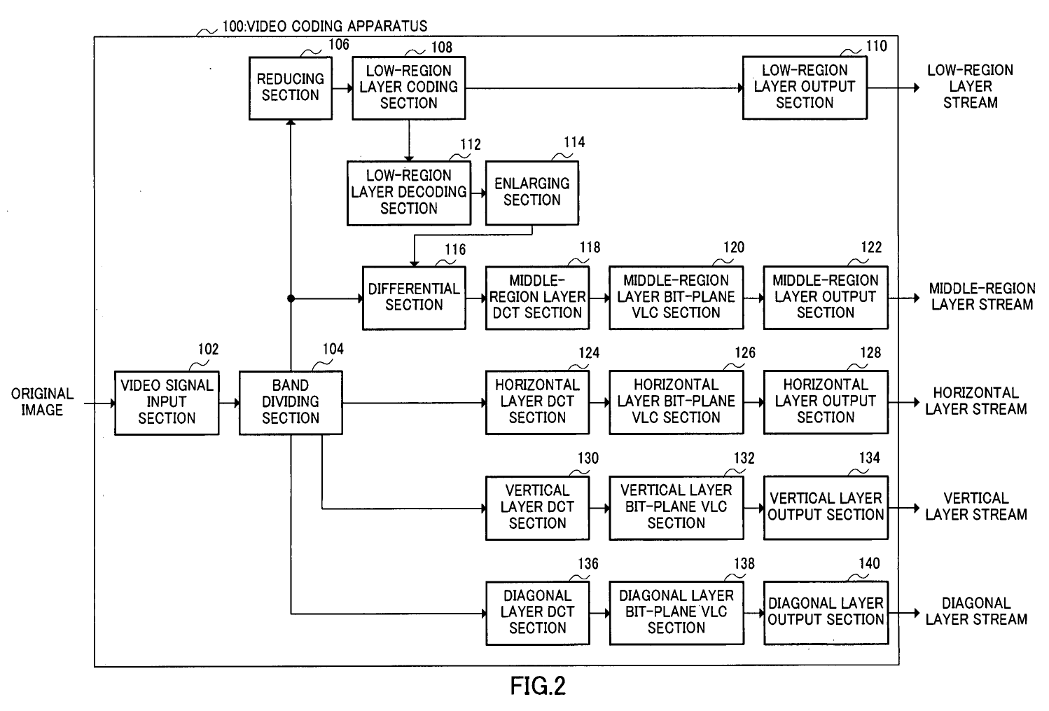

FIG. 2 is a block diagram illustrating a configuration of a video coding apparatus to which is applied a video coding method according to Embodiment 1 of the present invention.

Video coding apparatus 100 as shown in FIG. 2 has video signal input section 102, band dividing section 104, reducing section 106, low-region layer coding section 108, low-region layer output section 110, low-region layer decoding section 112, enlarging section 114, differential section 116, middle-region layer DCT section 118, middle-region layer bit-plane VLC section 120, middle-region layer output section 122, horizontal layer DCT section 124, horizontal layer bit-plane VLC section 126, horizontal layer output section 128, vertical layer DCT section 130, vertical layer bit-plane VLC section 132, vertical layer output section 134, diagonal layer DCT section 136, diagonal layer bit-plane VLC section 138 and diagonal layer output section 140.

Streams generated in video coding apparatus 100 include a low-region layer stream enabling decoding thereof alone to generate a low-resolution decoded image, a middle-region layer stream to add to the low-resolution decoded image to generate a middle-resolution decoded image, and a horizontal layer stream, vertical layer stream and diagonal layer stream each to add to the middle-resolution decoded image to generate a high-resolution decoded image.

Video signal input section 102 inputs a high-resolution original image on a frame-by-frame basis. In other words, the section 102 receives video with high resolution, and provides the input video on a frame-by-frame basis as a high-resolution original image to band dividing section 104.

Band dividing section 104 divides the high-resolution original image obtained by video signal input section 102 into four band components. In other words, the section 104 obtains the high-resolution original image from video signal input section 102, performs band division to divide the image into four components, specifically, a middle-resolution image, horizontal component, vertical component and diagonal component, and provides the middle-resolution image to reducing section 106 and differential section 116, the horizontal component to horizontal layer DCT section 124, the vertical component to vertical layer DCT section 130 and the diagonal component to diagonal layer DCT section 136.

In addition, in this specification, “sub-band components” mean band components except the middle-resolution image, i.e. the horizontal component, vertical component and diagonal component.

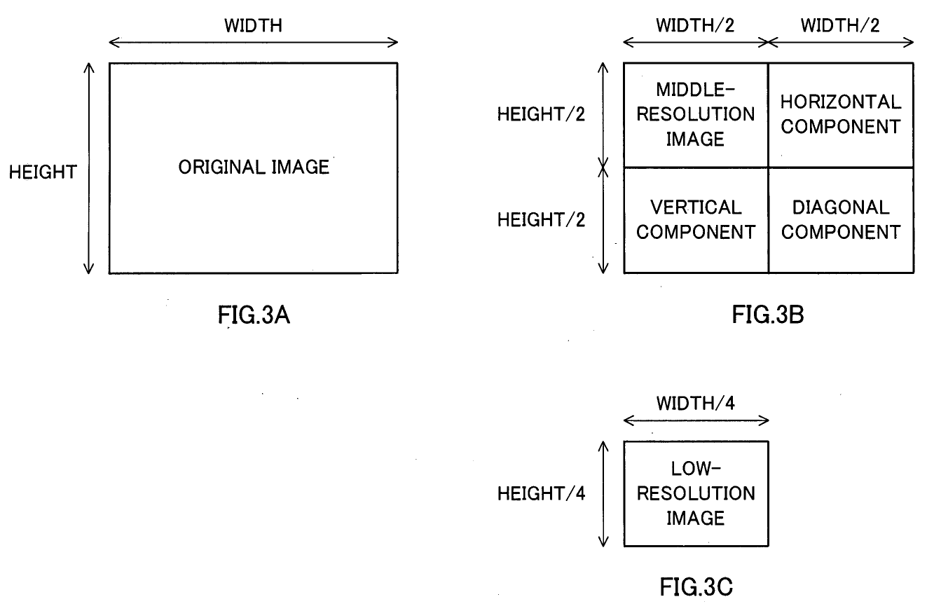

FIG. 3A illustrates a high-resolution original image before band division, and FIG. 3B illustrates each band component after band division.

Each band component has the resolution half that of the high-resolution original image both in vertical and horizontal directions, and the number of pixels one-fourth that of the original image. The middle-resolution image is a reduced image of the high-resolution original image. The horizontal component is an error component in the horizontal direction between the high-resolution original image and an image obtained by enlarging the middle-resolution image twice both in horizontal and vertical directions. The vertical component is an error component in the vertical direction between the high-resolution original image and an image obtained by enlarging the middle-resolution image twice both in horizontal and vertical directions. The diagonal component is an error component in the diagonal direction between the high-resolution original image and an image obtained by enlarging the middle-resolution image twice both in horizontal and vertical directions.

Following equations 1 to 4 represent an example of the band division method:
a[x][y]=(p[2x][2y]+p[2x+1][2y]+p[2x][2y+1]+p[2x+1][2y+1])/4 (Eq. 1)
h[x][y]=(−p[2x][2y]+p[2x+1][2y]+p[2x][2y+1]+p[2x+1][2y+1])/4 (Eq. 2)
v[x][y]=(−p[2x][2y]−p[2x+1][2y]+p[2x][2y+1]+p[2x+1][2y+1])/4 (Eq. 3)
d[x][y]=(−p[2x][2y]+p[2x+1][2y]+p[2x][2y+1]−p[2x+1][2y+1])/4 (Eq. 4)

In this band division method, the high-resolution original image is divided into blocks each with four pixels where two pixels are aligned in either the vertical or horizontal direction. The middle-resolution image and horizontal, vertical and diagonal components are calculated corresponding to coordinates of the four pixels. Herein, “p” is a pixel value of the high-resolution original image, and subscripts “x” and “y” are pixels values of coordinates (x,y) with the upper left set as an origin, respectively.

The “a” calculated in (Eq. 1) represents a pixel value of the middle-resolution decoded image, and a mean value of “p” of the four pixels. The “h” calculated in (Eq. 2) represents a pixel value of the horizontal component, and is a value obtained by subtracting a sum of two pixels on the left side from a sum of two pixels on the right side. The “v” calculated in (Eq. 3) represents a pixel value of the vertical component, and is a value obtained by subtracting a sum of two pixels on the lower side from a sum of two pixels on the upper side. The “d” calculated in (Eq. 4) represents a pixel value of the diagonal component, and is a value obtained by subtracting a sum of two pixels, upper-right pixel and lower-left pixel, from a sum of two pixels, upper-left pixel and lower-right pixel.

In addition, the band division method represented by (Eq. 1) to (Eq. 4) is merely one example, and the present invention is not limited thereto. For example, band division may be carried out using Daubechies or Meyer wavelet function, or a combination of a high pass filter, low pass filter and downsampler.

Reducing section 106 reduces the middle-resolution image obtained by the band division in band dividing section 104 to generate a low-resolution image. In other words, the section 106 obtains the middle-resolution image from band dividing section 104, reduces the obtained middle-resolution image to generate the low-resolution image, and provides the generated image to low-region layer coding section 108.

FIG. 3C illustrates a low-resolution image. The resolution of the low-resolution image is one-fourth that of the high-resolution image in both vertical and horizontal directions, and the number of pixels of the low-resolution image is one-sixteenth that of the high-resolution image.

Low-region layer coding section 108 encodes the low-resolution image obtained by reducing section 106 to generate a low-region layer stream. In this Embodiment, from the viewpoint of compatibility with a preexisting method and apparatus, used as a coding method in low-region layer coding section 108 is well-known MPEG-4 ASP (Advanced Simple Profile). In other words, the section 108 obtains the low-resolution image from reducing section 106, subjects the obtained low-resolution image to DCT, quantization, VLC, predictive coding, etc, generates a low-region layer stream enabling decoding thereof alone, and provides the generated stream to low-region layer output section 110 and low-region layer decoding section 112.

In addition, as a matter of course, the coding method in the section 108 is not limited to MPEG-4 ASP, and other coding method may be used.

Low-region layer output section 110 outputs the low-region layer stream obtained by low-region layer coding section 108 to the outside. In other words, the section 110 obtains the low-region layer stream obtained by low-region layer coding section 108, and outputs the obtained stream to the outside of video coding apparatus 100.

Low-region layer decoding section 112 decodes the low-region layer stream obtained by low-region layer coding section 108 to generate a low-resolution decoded image. In other words, the section 112 obtains the low-region layer stream from low-region layer coding section 108, decodes the obtained low-region stream to generate a low-resolution decoded image, and provides the generated image to enlarging section 114.

Enlarging section 114 enlarges the low-resolution decoded image obtained by low-region layer decoding section 112. In other words, the section 114 obtains the low-resolution decoded image from low-region layer decoding section 112, enlarges the obtained low-resolution decoded image to generate an enlarged low-resolution decoded image, and provides the generated image to differential section 116. The resolution of the enlarged low-resolution decoded image is equal to the resolution of the middle-resolution image.

In this Embodiment, from the viewpoint of compatibility with a preexisting method and apparatus, the enhancement layer coding method of MPEG-4 FGS is used as a coding method in differential section 116, middle-region layer DCT section 118 and middle-region layer bit-plane VLC section 120.

Herein, the bit plane is a bit sequence where bits in the same bit position are arranged from some binary numbers. Bit-plane VLC is a coding method for performing variable length coding for each bit plane.

The concept of bit-plane coding will be described briefly below.

For example, a case is considered of transmitting four integers, “5”, “14”, “3” and “15”, which are arbitrarily chosen from decimal integers of 0 to 15. Converting decimal “5”, “14”, “3” and “15” to 4-bit binary numbers obtain “0101”, “1110”, “0011” and “1111”. Arranging the numbers in descending order of significant bit for each bit plane obtains “0101”, “1101”, “0111” and “1011”. When the transmission rate is limited, transmitting preferentially from the upper bit plane reduces deterioration of information. More specifically, when only three bit planes can be transmitted, decimal “4”, “14”, “2” and “14” are obtained from “0101”, “1101” and “0111”.

Using bit-plane coding in video coding enables selection of image equality in decoding corresponding to the number of bit planes, i.e. enables image quality scalability to be obtained.

Further, bit-plane VLC that is VLC used in bit-plane coding will be described briefly below.

Bit-plane VLC uses zero runlength coding, performs scanning of 8×8 DCT coefficients, and using the number of “0”s which appear until “1” appears, and an EOP (End Of Plane) signal indicating that “1” does not appear in subsequent scanning on the bit plane, performs variable length coding. Herein, “scanning” means the processing for performing variable length coding on DCT coefficients sequentially.

Differential section 116 generates a differential image from the middle-resolution image obtained by band dividing section 104 and the enlarged low-resolution decoded image obtained by enlarging section 114. In other words, the section 116 obtains the middle-resolution image from band dividing section 104 and the enlarged low-resolution decoded image from enlarging section 114, calculates a difference between the images to generate a difference image, and provides the generated image to middle-region layer DCT section 118.

Middle-region layer DCT section 118 performs DCT processing on the differential image obtained by differential section 116. In other words, the section 118 obtains the differential image from differential section 116, performs the DCT processing on the obtained differential image on an 8×8 pixel block basis to generate middle-region component DCT coefficients, and provides the generated coefficients to middle-region layer bit-plane VLC section 120.

Middle-region layer bit-plane VLC section 120 performs bit-plane VLC processing on the differential image subjected to the DCT processing obtained by middle-region layer DCT section 118 to generate a middle-region layer stream. In other words, the section 120 obtains the middle-region component DCT coefficients from middle-region layer DCT section 118, performs the VLC processing on the obtained middle-region component DCT coefficients for each bit plane to generate a middle-region layer stream, and provides the generated stream to middle-region layer output section 122.

Middle-region layer output section 122 outputs the middle-region layer stream obtained by middle-region layer bit-plane VLC section 120 to the outside. In other words, the section 122 obtains the middle-region layer stream from middle-region layer bit-plane VLC section 120, and outputs the obtained stream to the outside of video coding apparatus 100.

Horizontal layer DCT section 124 performs the DCT processing on the horizontal component obtained by band division in band dividing section 104. In other words, the section 124 obtains the horizontal component from band dividing section 104, performs the DCT processing on the obtained horizontal component on an 8×8 pixel block basis to generate horizontal component DCT coefficients, and provides the generated coefficients to horizontal layer bit-plane VLC section 126.

Horizontal layer bit-plane VLC section 126 performs the bit-plane VLC processing on the horizontal component subjected to the DCT processing obtained by horizontal layer DCT section 124 to generate a horizontal layer stream. In other words, the section 126 obtains the horizontal component DCT coefficients from horizontal layer DCT section 124, performs the VLC processing on the obtained horizontal component DCT coefficients for each bit plane to generate a horizontal layer stream, and provides the generated stream to horizontal layer output section 128.

Horizontal layer output section 128 outputs the horizontal layer stream obtained by horizontal layer bit-plane VLC section 126 to the outside. In other words, the section 128 obtains the horizontal layer stream from horizontal layer bit-plane VLC section 126, and outputs the obtained stream to the outside of video coding apparatus 100.

Vertical layer DCT section 130 performs the DCT processing on the vertical component obtained by band division in band dividing section 104. In other words, the section 130 obtains the vertical component from band dividing section 104, performs the DCT processing on the obtained vertical component on an 8×8 pixel block basis to generate vertical component DCT coefficients, and provides the generated coefficients to vertical layer bit-plane VLC section 132.

Vertical layer bit-plane VLC section 132 performs the bit-plane VLC processing on the vertical component subjected to the DCT processing obtained by vertical layer DCT section 130 to generate a vertical layer stream. In other words, the section 132 obtains the vertical component DCT coefficients from vertical layer DCT section 130, performs the VLC processing on the obtained vertical component DCT coefficients for each bit plane to generate a vertical layer stream, and provides the generated stream to vertical layer output section 134.

Vertical layer output section 134 outputs the vertical layer stream obtained by vertical layer bit-plane VLC section 132 to the outside. In other words, the section 134 obtains the vertical layer stream from vertical layer bit-plane VLC section 132, and outputs the obtained stream to the outside of video coding apparatus 100.

Diagonal layer DCT section 136 performs the DCT processing on the diagonal component obtained by band division in band dividing section 104. In other words, the section 136 obtains the diagonal component from band dividing section 104, performs the DCT processing on the obtained diagonal component on an 8×8 pixel block basis to generate diagonal component DCT coefficients, and provides the generated coefficients to diagonal layer bit-plane VLC section 138.

Diagonal layer bit-plane VLC section 138 performs the bit-plane VLC processing on the diagonal component subjected to the DCT processing obtained by diagonal layer DCT section 136 to generate a diagonal layer stream. In other words, the section 138 obtains the diagonal component DCT coefficients from diagonal layer DCT section 136, performs the VLC processing on the obtained diagonal component DCT coefficients for each bit plane to generate a diagonal layer stream, and provides the generated stream to diagonal layer output section 140.

Diagonal layer output section 140 outputs the diagonal layer stream obtained by diagonal layer bit-plane VLC section 138 to the outside. In other words, the section 140 obtains the diagonal layer stream from diagonal layer bit-plane VLC section 138, and outputs the obtained stream to the outside of video coding apparatus 100.

Following descriptions are given of coding of the horizontal component, vertical component and diagonal component generated in band division that is the gist of the present invention.

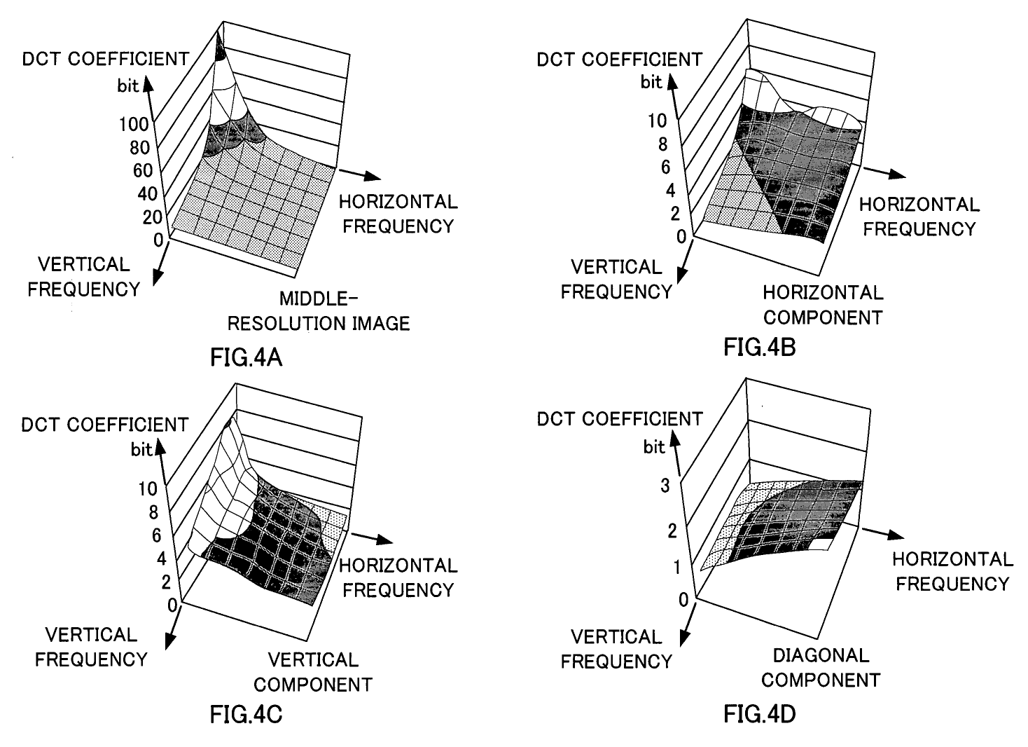

FIGS. 4A to 4D are three-dimensional graphs illustrating an example of statistics of absolute values of DCT coefficients of four band components in FIG. 3B. Herein, for example, original video is hundred sheets of moving picture of a person of 352×288 pixels. The DCT processing is carried out on the moving picture on an 8×8 pixel block basis, and a mean value of absolute values is calculated for each frequency component on DCT coefficients of all the pixel blocks of all the images.

FIG. 4A illustrates an example of statistics of absolute values of DCT coefficients of the middle-resolution image. It is understood from this graph that the DCT coefficients of the middle-resolution image distribute, while being biased toward horizontal low frequencies and vertical low frequencies.

FIG. 4B illustrates an example of statistics of absolute values of DCT coefficients of the horizontal component. It is understood from this graph that the DCT coefficients of the horizontal component distribute, while being biased toward vertical low frequencies. Particularly, the DCT coefficients of the horizontal component are the smallest both in horizontal low frequencies and vertical high frequencies statistically.

FIG. 4C illustrates an example of statistics of absolute values of DCT coefficients of the vertical component. It is understood from this graph that the DCT coefficients of the vertical component distribute, while being biased toward horizontal low frequencies. Particularly, the DCT coefficients of the vertical component are the smallest both in vertical low frequencies and horizontal high frequencies statistically.

FIG. 4D illustrates an example of statistics of absolute values of DCT coefficients of the diagonal component. It is understood from this graph that the DCT coefficients of the diagonal component distribute, while being biased toward horizontal high frequencies and vertical high frequencies. Particularly, the DCT coefficients of the diagonal component are the smallest both in horizontal low frequencies and vertical low frequencies statistically.

The inventors of the present invention found out that statistical predetermined bias exists on the distribution of DCT coefficients of each component obtained by band division, and based on which, have reached the present invention. In other words, in the present invention, DCT processing is performed on each component obtained by subjecting an image with some resolution to band division to cause predetermined bias to occur on the distribution of DCT coefficients for each band component (see FIGS. 4A to 4D), and using the bias (statistical result), coding efficiency is improved.

The method will be described specifically below.

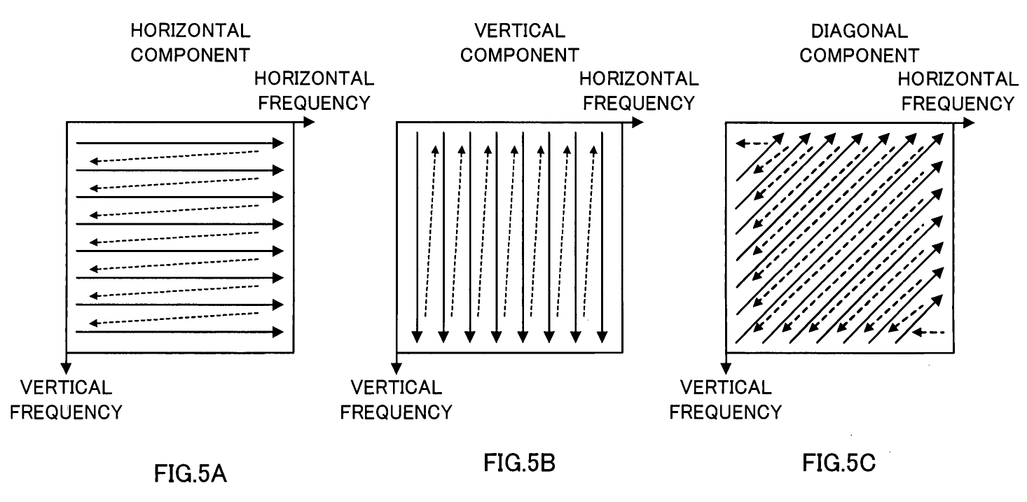

FIGS. 5A to 5C are views illustrating an example of the scanning order of 8×8 DCT coefficients of each component. Herein, FIG. 5A is a view showing an example of a scanning order of 8×8 DCT coefficients of the horizontal component, FIG. 5B is a view showing an example of a scanning order of 8×8 DCT coefficients of the vertical component, and FIG. 5C is a view showing an example of a scanning order of 8×8 DCT coefficients of the diagonal component. In FIGS. 5A to 5C, scanning is performed in the order of arrows. In other words, zigzag scanning is carried out.

Herein, as an example, zigzag scanning on the horizontal component will be described below.

As described above, FIG. 5A shows an example of the scanning order in which the DCT coefficients of 8×8 pixel block of the horizontal component are subjected to the bit-plane VLC processing, and scanning (zigzag scanning) is performed in the order of arrows. That is, based on the statistical result as shown in FIG. 4B, in other words, noting the respect that the DCT coefficients of the horizontal component distribute, while being biased toward vertical low frequencies, 64 DCT coefficients are horizontally scanned sequentially from vertical low to high frequencies, giving priorities to vertical low frequencies. By this means, in the bit-plane VLC processing, a large number of values of “1” appear at the beginning of scanning in the bit plane, while a large number of values of “0” appear at the end of scanning, and it is thereby possible to decrease a coding length using the EOP signal. In addition, scanning is carried out in the predetermined order during coding.

To describe more details, the scanning order is not limited to examples as shown in FIGS. 5A to 5C.

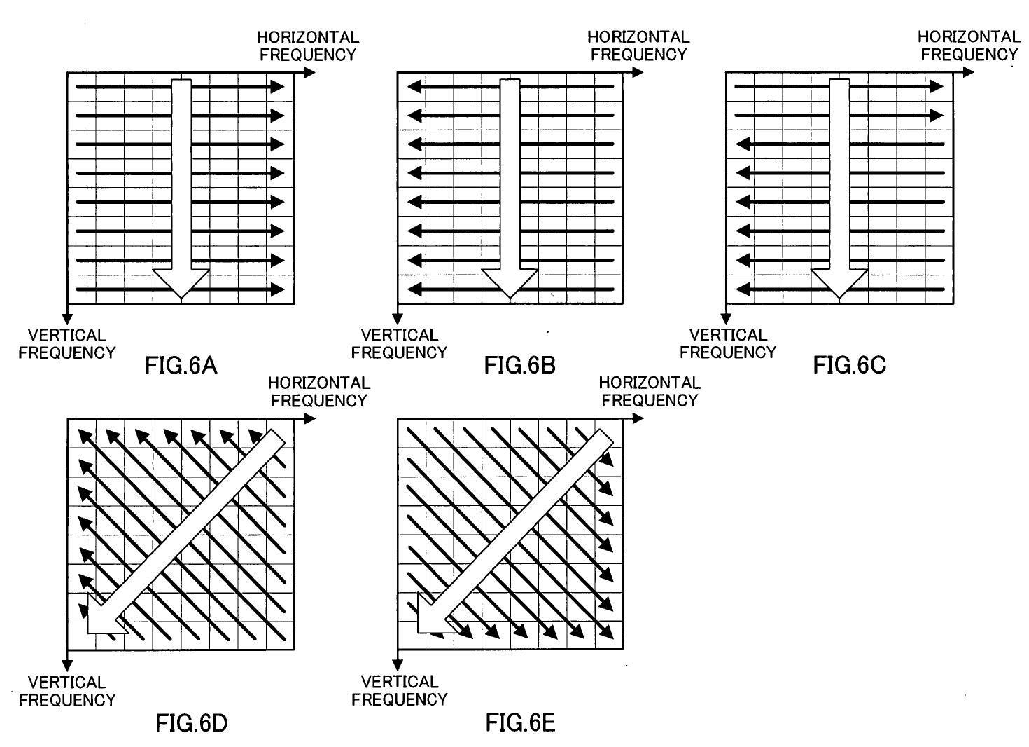

FIGS. 6A to 6E show examples of the scanning order on the horizontal component. As described above, since the DCT coefficients of the horizontal component are the smallest in horizontal low frequencies and vertical high frequencies statistically, for example, following four modes are available:
Scan from vertical low frequencies to vertical high frequencies in the horizontal frequency axis direction (from horizontal low frequencies to horizontal high frequencies) (see FIG. 6A);
Scan from vertical low frequencies to vertical high frequencies in the horizontal frequency axis direction (from horizontal high frequencies to horizontal low frequencies) (see FIG. 6B);
Scan from vertical low frequencies to vertical high frequencies in the horizontal frequency axis direction while changing the direction (from horizontal low frequencies to horizontal high frequencies in vertical low frequencies, and from horizontal high frequencies to horizontal low frequencies in vertical high frequencies) (see FIG. 6C);
Scan from horizontal high frequencies and vertical low frequencies to horizontal low frequencies and vertical high frequencies in the slanting direction (from horizontal high frequencies and vertical low frequencies to horizontal low frequencies and vertical high frequencies) (see FIG. 6D); and
Scan from horizontal high frequencies and vertical low frequencies to horizontal low frequencies and vertical high frequencies in the slanting direction (from horizontal low frequencies and vertical low frequencies to horizontal high frequencies and vertical high frequencies) (see FIG. 6E).

In addition, FIG. 5A corresponds to FIG. 6A.

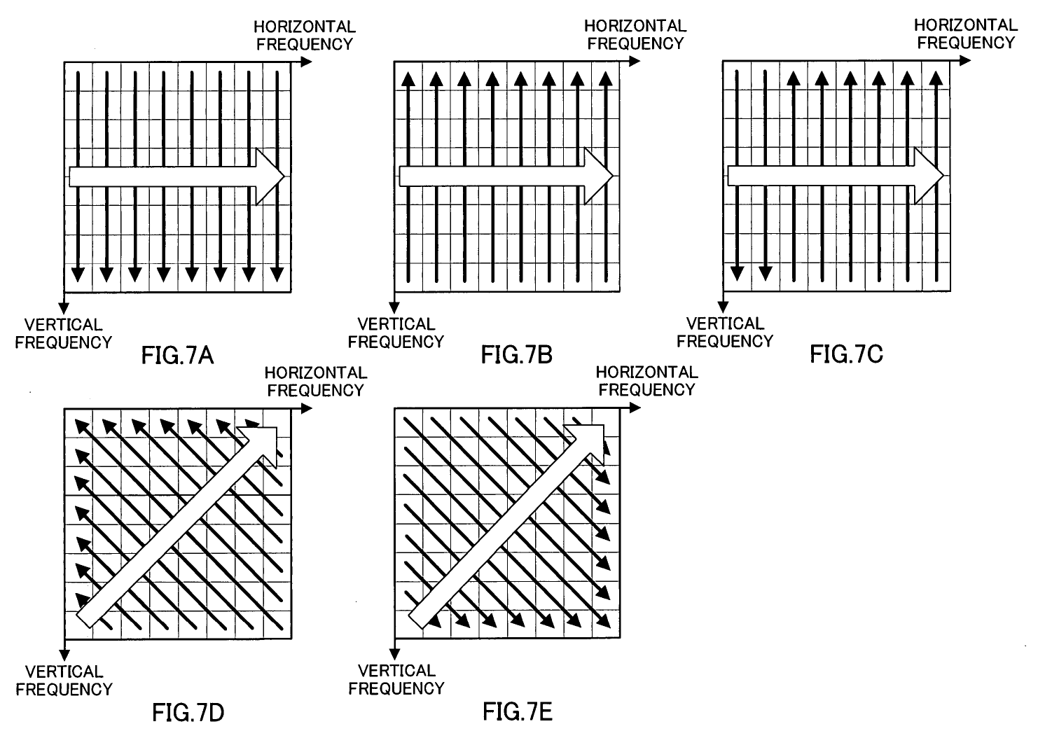

FIGS. 7A to 7E show examples of the scanning order on the vertical component. As described above, since the DCT coefficients of the vertical component are the smallest in vertical low frequencies and horizontal high frequencies statistically, for example, following four modes are available:
Scan from horizontal low frequencies to horizontal high frequencies in the vertical frequency axis direction (from vertical low frequencies to vertical high frequencies) (see FIG. 7A);
Scan from horizontal low frequencies to horizontal high frequencies in the vertical frequency axis direction (from vertical high frequencies to vertical low frequencies) (see FIG. 7B);
Scan from horizontal low frequencies to horizontal high frequencies in the vertical frequency axis direction while changing the direction (from vertical low frequencies to vertical high frequencies in horizontal low frequencies, and from vertical high frequencies to vertical low frequencies in horizontal high frequencies) (see FIG. 7C);
Scan from horizontal low frequencies and vertical high frequencies to horizontal high frequencies and vertical low frequencies in the slanting direction (from horizontal high frequencies and vertical high frequencies to horizontal low frequencies and vertical low frequencies) (see FIG. 7D); and
Scan from horizontal low frequencies and vertical high frequencies to horizontal high frequencies and vertical low frequencies in the slanting direction (from horizontal low frequencies and vertical low frequencies to horizontal high frequencies and vertical high frequencies) (see FIG. 7E).

In addition, FIG. 5B corresponds to FIG. 7A.

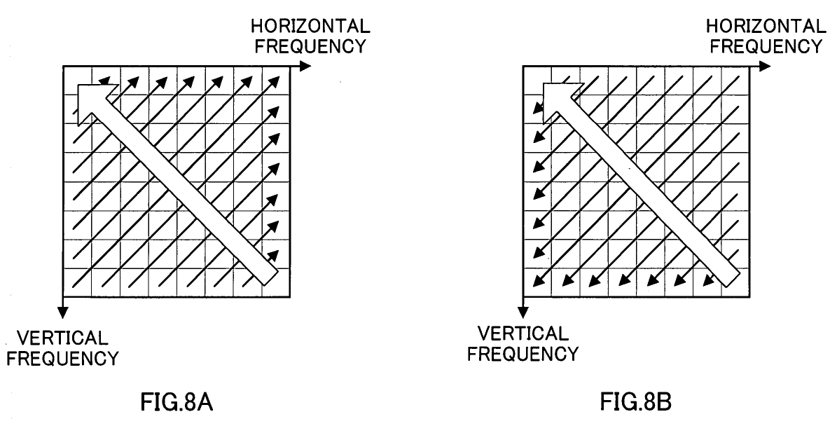

FIGS. 8A and 8B show examples of the scanning order on the diagonal component. As described above, since the DCT coefficients of the diagonal component are the smallest in horizontal low frequencies and vertical low frequencies statistically, for example, following two modes are available:
Scan from horizontal high frequencies and vertical high frequencies to horizontal low frequencies and vertical low frequencies in the slanting direction (from horizontal low frequencies and vertical high frequencies to horizontal high frequencies and vertical low frequencies) (see FIG. 8A); and
Scan from horizontal high frequencies and vertical high frequencies to horizontal low frequencies and vertical low frequencies in the slanting direction (from horizontal high frequencies and vertical low frequencies to horizontal low frequencies and vertical high frequencies) (see FIG. 8B).

In addition, FIG. 5C corresponds to FIG. 8A.

Limitations in scanning range will be described below.

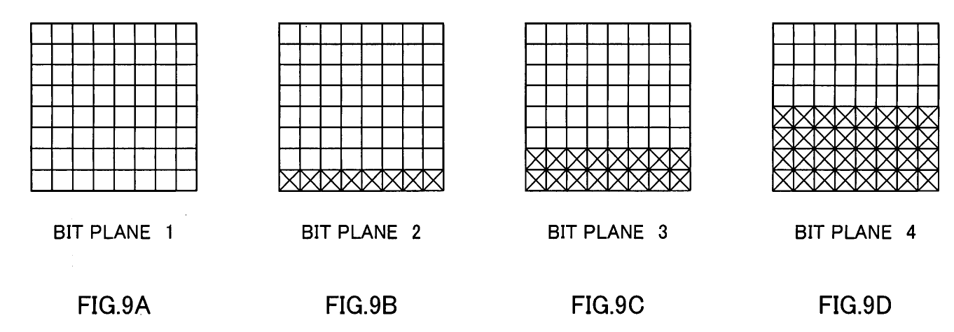

FIGS. 9A to 9D show examples of the number of DCT coefficients (i.e. a range of scanning) for each bit plane subjected to scanning in the scanning order as shown in FIG. 5A. Herein, FIG. 9A shows bit plane 1 including the most significant bits with a value of “1” among the DCT coefficients, FIG. 9B shows bit plane 2 including bits one-bit less significant than those of bit plane 1, FIG. 9C shows bit plane 3 including bits one-bit less significant than those of bit plane 2, and FIG. 9D shows bit plane 4 including bits one-bit less significant than those of bit plane 3. In FIGS. 9B to 9D, crosses represent that DCT coefficients with the crosses are not scanned, i.e. not encoded.

The reason why a range of scanning can thus be limited for each bit plane is that a bit plane with more significant bits exerts a greater effect on the image quality of a decoded image, a bit plane with less significant bits exerts a smaller effect on the image quality of a decoded image, and that as shown in FIG. 4B, the vertical high frequency component has a smaller value than that of the vertical low frequency component and thus exerts a smaller effect on the image quality among the DCT coefficients of the horizontal component. Accordingly, as shown in FIGS. 9A to 9D, as a bit plane to encode has less significant bits, the length of scanning of DCT coefficients is decreased to preferentially encode the vertical low frequency component and omit coding of the vertical high frequency component, and it is thereby possible to improve the coding efficiency and coding rate. In addition, the length of scanning of each bit plane maybe predetermined, or varied adaptively in accordance with the number of bit planes.

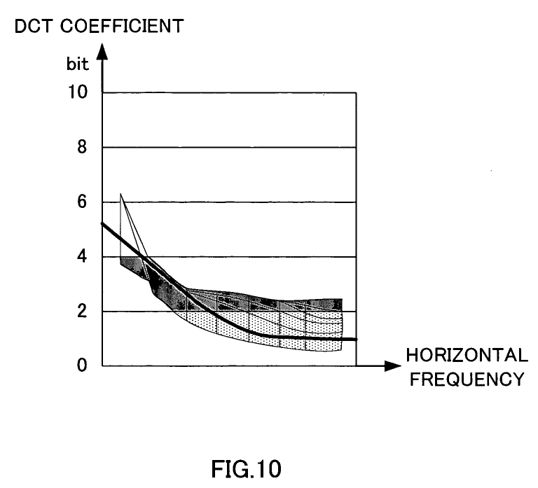

A coding target is not limited to the DCT coefficient itself. For example, FIG. 10 is a graph as viewed from the direction parallel to the horizontal frequency axis in the graph of absolute values of DCT coefficients of the horizontal component as shown in FIG. 4B. By approximating the DCT coefficients using the bold line as shown in FIG. 10, another quadratic function, plane function, or the like and performing the bit-plane VLC processing (or, quantization and VLC processing) on the error, an amount of information to encode is reduced when the error is small, and it is thus possible to obtain high coding efficiency.

The aforementioned descriptions on coding of the horizontal component are the same as on coding of DCT coefficients of the vertical component and diagonal component. In other words, based on statistical results as shown in FIGS. 4C and 4D, for example, more biased DCT coefficients are preferentially biased according to the scanning order of FIGS. 5C and SD, respectively. Further, as a bit plane to encode has less significant bits, scanning of less biased DCT coefficients is omitted.

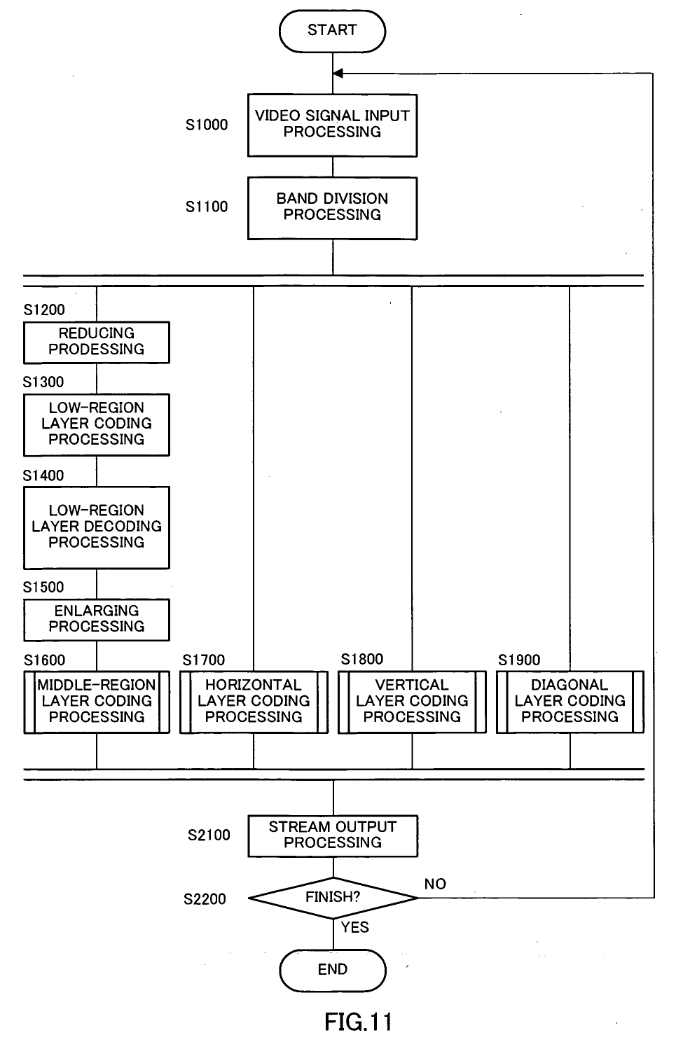

The operation of video coding apparatus 100 with the configuration as described above will be described below with reference to a flowchart as shown in FIG. 11. The flowchart as shown in FIG. 11 is stored as a control program in a storage device (for example, such as ROM and flash memory), not shown, of video coding apparatus 100, and executed by a CPU, not shown either.

First, in step S1000, video signal input processing is carried out to input a video signal. More specifically, video signal input section 102 detects a synchronization signal from an input video signal, and provides to band dividing section 104 an original image constituting the video signal on a frame-by-frame basis as a high-resolution image.

Then, in step S1100 is carried out band division processing of the image. More specifically, band dividing section 104 performs band division on the high-resolution original image obtained from video signal input section 102 using (Eq. 1) to (Eq. 4) as described earlier, and provides the middle-resolution image to reducing section 106 and differential section 116, the horizontal component to horizontal layer DCT section 124, the vertical component to vertical layer DCT section 130 and the diagonal component to diagonal layer DCT section 136.

Subsequently, processing of steps S1200 to S1600, and steps S1700, S1800, and S1900 is carried out in parallel.

In step S1200 is carried out reducing processing of the image. More specifically, reducing section 106 reduces the middle-resolution image obtained from band dividing section 104 to generate a low-resolution image, and provides the generated image to low-region layer coding section 108.

Then, in step S1300 is carried out low-region layer coding processing to encode the low-resolution image. In this Embodiment, as described above, from the viewpoint of compatibility with a preexisting method and apparatus, well-known MPEG-4 ASP is used as a coding method of the low-region layer coding processing. More specifically, low-region layer coding section 108 performs MPEG coding such as DCT, quantization, VLC and predictive coding on the low-resolution image obtained from reducing section 106, generates a low-region layer stream enabling decoding thereof alone, and provides the generated stream to low-region layer output section 110 and low-region layer decoding section 112. In step S1400 is carried out low-region layer decoding processing to decode the low-resolution image. More specifically, low-region layer decoding section 112 decodes the low-region layer stream obtained from low-region layer coding section 108 to generate a low-resolution decoded image, and provides the generated image to enlarging section 114.

In step S1500 is carried out enlarging processing to enlarge the image. More specifically, enlarging section 114 enlarges the low-resolution decoded image obtained from low-region layer decoding section 112 to generate an enlarged low-resolution decoded image, and provides the enlarged image to differential section 116. In addition, the resolution of the enlarged low-resolution decoded image is equal to the resolution of the middle-resolution image, as described above.

In step S1600 is carried out middle-region layer coding processing to encode the middle-resolution image. In this Embodiment, as described above, from the viewpoint of compatibility with a preexisting method and apparatus, the middle-region layer coding processing is the same as the enhancement layer coding processing in MPEG-4 FGS.

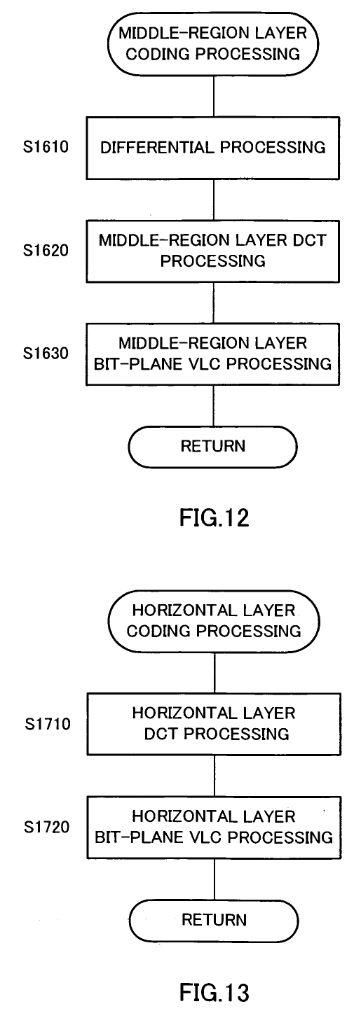

FIG. 12 is a flowchart illustrating an example of procedures of the middle-region layer coding processing in FIG. 11.

First, in step S1610 is carried out differential processing. More specifically, differential section 116 calculates a difference between the middle-resolution image obtained from band dividing section 104 and the enlarged low-resolution decoded image obtained from enlarging section 114 to generate a differential image, and provides the generated image to middle-region layer DCT section 118.

In step S1620 is carried out middle-region layer DCT processing. More specifically, middle-region layer DCT section 118 performs the DCT processing on the differential image obtained from differential section 116 to generate middle-region component DCT coefficients, and provides the generated coefficients to middle-region layer bit-plane VLC section 120.

In step S1630 is carried out middle-region layer bit-plane VLC processing. More specifically, middle-region layer bit-plane VLC section 120 performs bit-plane VLC processing on the middle-region component DCT coefficients obtained from middle-region layer DCT section 118 to generate a middle-region layer stream, and provides the generated stream to middle-region layer output section 122. Then, the processing flow returns to the flowchart in FIG. 11.

Meanwhile, in step S1700 is carried out horizontal layer coding processing to encode the horizontal component.

FIG. 13 is a flowchart illustrating an example of procedures of the horizontal layer coding processing in FIG. 11.

First, in step S1710 is carried out horizontal layer DCT processing. More specifically, horizontal layer DCT section 124 performs the DCT processing on the horizontal component obtained from band dividing section 104 to generate horizontal component DCT coefficients, and provides the generated coefficients to horizontal layer bit-plane VLC section 126.

In step S1720 is carried out horizontal layer bit-plane VLC processing. More specifically, horizontal layer bit-plane VLC section 126 performs the bit-plane VLC processing on the horizontal component DCT coefficients obtained from horizontal layer DCT section 124 to generate a horizontal layer stream, and provides the generated stream to horizontal layer output section 128. Then, the processing flow returns to the flowchart in FIG. 11.

Meanwhile, in step S1800 is carried out vertical layer coding processing to encode the vertical component.

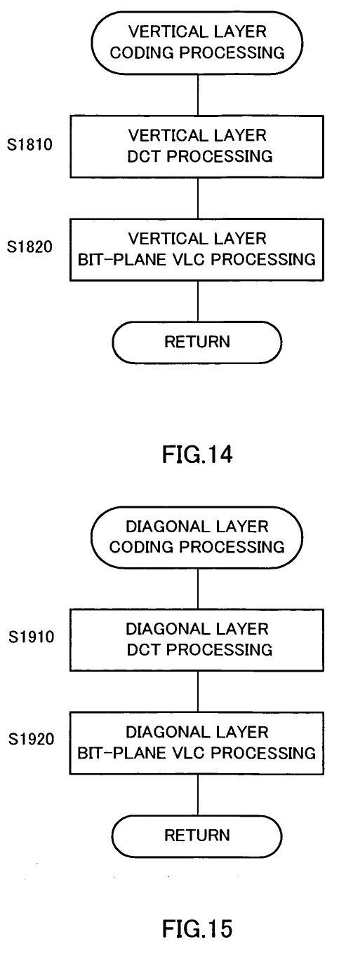

FIG. 14 is a flowchart illustrating an example of procedures of the vertical layer coding processing in FIG. 11.

First, in step S1810 is carried out vertical layer DCT processing. More specifically, vertical layer DCT section 130 performs the DCT processing on the vertical component obtained from band dividing section 104 to generate vertical component DCT coefficients, and provides the generated coefficients to vertical layer bit-plane VLC section 132.

In step S1820 is carried out vertical layer bit-plane VLC processing. More specifically, vertical layer bit-plane VLC section 132 performs the bit-plane VLC processing on the vertical component DCT coefficients obtained from vertical layer DCT section 130 to generate a vertical layer stream, and provides the generated stream to vertical layer output section 134. Then, the processing flow returns to the flowchart in FIG. 11.

Meanwhile, in step S1900 is carried out diagonal layer coding processing to encode the diagonal component.

FIG. 15 is a flowchart illustrating an example of procedures of the diagonal layer coding processing in FIG. 11.

First, in step S1910 is carried out diagonal layer DCT processing. More specifically, diagonal layer DCT section 136 performs the DCT processing on the diagonal component obtained from band dividing section 104 to generate diagonal component DCT coefficients, and provides the generated coefficients to diagonal layer bit-plane VLC section 138.

In step S1920 is carried out diagonal layer bit-plane VLC processing. More specifically, diagonal layer bit-plane VLC section 138 performs the bit-plane VLC processing on the diagonal component DCT coefficients obtained from diagonal layer DCT section 136 to generate a diagonal layer stream, and provides the generated stream to diagonal layer output section 140. Then, the processing flow returns to the flowchart in FIG. 11.

Subsequently, in step S2100, stream output processing is carried out to output streams generated in steps S1600 to S1900. More specifically, low-region layer output section 110 outputs the low-region layer stream obtained from low-region layer coding section 108 to the outside of video coding apparatus 100. Middle-region layer output section 122 outputs the middle-region layer stream obtained from middle-region layer bit-plane VLC section 120 to the outside of video coding apparatus 100. Horizontal layer output section 128 outputs the horizontal layer stream obtained from horizontal layer bit-plane VLC section 126 to the outside of video coding apparatus 100. Vertical layer output section 134 outputs the vertical layer stream obtained from vertical layer bit-plane VLC section 132 to the outside of video coding apparatus 100. Diagonal layer output section 140 outputs the diagonal layer stream obtained from diagonal layer bit-plane VLC section 138 to the outside of video coding apparatus 100.

Then, in step S2200, coding finish determination processing is carried out to determine whether or not to finish a series of the video coding processing. More specifically, for example, video signal input section 102 determines the presence or absence of video to be input from the outside of video coding apparatus 100, and determines that the coding processing is continued when input video exists (S2200: NO), thereby returning to step S1000, while determining that the coding processing is finished when any input video does not exist (S2200: YES), thereby finishing a series of the video coding processing.

As described in the foregoing, in the video coding, video is coded to generate a plurality of video streams.

A video decoding method will be described below to decode a video stream coded in this Embodiment.

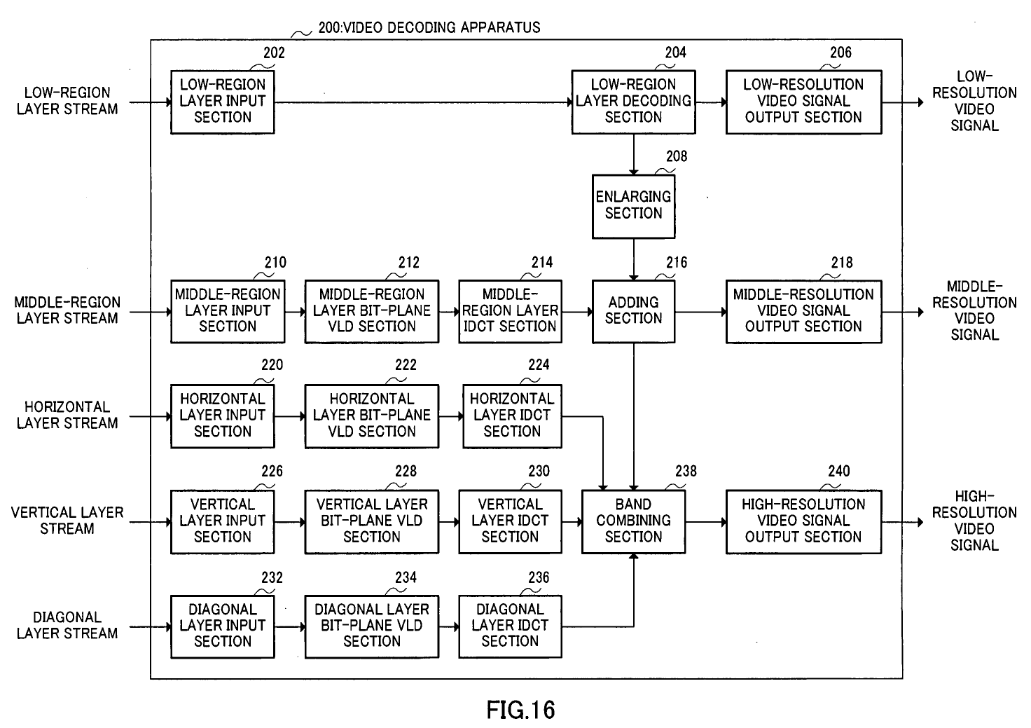

FIG. 16 is a block diagram illustrating a configuration of a video decoding apparatus to which is applied a video decoding method according to Embodiment 1 of the present invention.

Video decoding apparatus 200 as shown in FIG. 16 decodes a layer stream of each band generated in video coding apparatus 100 as shown in FIG. 2, generates a decoded band component, performs band combining to combine each band, and obtains a high-resolution decoded image.

Video decoding apparatus 200 has low-region layer input section 202, low-region layer decoding section 204, low-resolution video signal output section 206, enlarging section 208, middle-region layer input section 210, middle-region layer bit-plane VLD section 212, middle-region layer IDCT section 214, adding section 216, middle-resolution video signal output section 218, horizontal layer input section 220, horizontal layer bit-plane VLD section 222,horizontal layer IDCT section 224, vertical layer input section 226, vertical layer bit-plane VLD section 228, vertical layer IDCT section 230, diagonal layer input section 232, diagonal layer bit-plane VLD section 234, diagonal layer IDCT section 236, band combining section 238, and high-resolution video signal output section 240.

Low-region layer input section 202 inputs a low-region layer stream. In other words, the section 202 receives the low-region layer stream from the outside of video decoding apparatus 200 to provide to low-region layer decoding section 204.

Low-region layer decoding section 204 decodes the low-region layer stream to generate a low-resolution decoded image. In this Embodiment, from the viewpoint of compatibility with a preexisting method and apparatus, used as a decoding method in low-region layer decoding section 204 is well-known MPEG-4 ASP. In other words, the section 204 obtains the low-region layer stream from low-region layer input section 202, subjects the obtained low-region layer stream to predictive decoding, VLD (Variable Length Decoding), dequantization, IDCT (Inverse Discrete Cosine Transform), etc, thereby performing MPEG decoding, generates the low-resolution decoded image, and provides the generated image to low-resolution video signal output section 206 and enlarging section 208. The resolution of the low-resolution decoded image is equal to the resolution of the middle-resolution image.

Low-resolution video signal output section 206 outputs the low-resolution decoded image to the outside of video decoding apparatus 200. In other words, the section 206 outputs the low-resolution decoded image obtained from low-region layer decoding section 204 to the outside of video decoding apparatus 200.

Enlarging section 208 enlarges the low-resolution decoded image. In other words, the section 208 enlarges the low-resolution decoded image obtained from low-region layer decoding section 204 to generate an enlarged low-resolution decoded image, and provides the generated image to adding section 216. In addition, in order to maintain consistency between coding and decoding, it is desired that enlarging section 208 uses the same enlarging processing algorithm as the algorithm in enlarging section 114 in video coding apparatus 100. The resolution of the enlarged low-resolution decoded image is equal to the resolution of the middle-resolution image.

Middle-region layer input section 210 inputs a middle-region layer stream. In other words, the section 210 receives the middle-region layer stream from the outside of video decoding apparatus 200 to provide to middle-region layer bit-plane VLD section 212.

In this Embodiment, from the viewpoint of compatibility with a preexisting method and apparatus, the enhancement layer decoding method of MPEG-4 FGS is used as a decoding method in middle-region layer bit-plane VLD section 212, middle-region layer IDCT section 214, and adding section 216.

Middle-region layer bit-plane VLD section 212 performs bit-plane VLD processing on the middle-region layer stream. In other words, the section 212 performs the bit-plane VLD processing on the middle-region layer stream obtained from middle-region layer input section 210 to generate middle-region component DCT coefficients, and provides the generated coefficients to middle-region layer IDCT section 214.

Middle-region layer IDCT section 214 performs IDCT (Inverse DCT) processing on the middle-region component DCT coefficients. In other words, the section 214 performs the IDCT processing on the middle-region component DCT coefficients obtained from middle-region layer bit-plane VLD section 212 to generate a decoded differential image, and provides the decoded image to adding section 216.

Adding section 216 adds images to generate a middle-resolution decoded image. In other words, the section 216 adds the enlarged low-resolution decoded image obtained from enlarging section 208 and the decoded differential image obtained from middle-region layer IDCT section 214 to generate a middle-resolution decoded image, and provides the generated image to middle-resolution video signal output section 218. The middle-resolution decoded image has the resolution half that of the coded high-resolution original image both in vertical and horizontal directions, and the number of pixels one-fourth that of the original image.

Middle-resolution video signal output section 218 outputs the middle-resolution decoded image to the outside of video decoding apparatus 200. In other words, the section 218 outputs the middle-resolution decoded image obtained from adding section 216 to the outside of video decoding apparatus 200.

Horizontal layer input section 220 inputs a horizontal layer stream. In other words, the section 220 receives the horizontal layer stream from the outside of video decoding apparatus 200 to provide to horizontal layer bit-plane VLD section 222.

Horizontal layer bit-plane VLD section 222 performs the bit-plane VLD processing on the horizontal layer stream. In other words, the section 222 performs the bit-plane VLD processing on the horizontal layer stream obtained from horizontal layer input section 220 to generate horizontal component DCT coefficients, and provides the generated coefficients to horizontal layer IDCT section 224.

Horizontal layer IDCT section 224 performs the IDCT processing on the horizontal component DCT coefficients. In other words, the section 224 performs the IDCT processing on the horizontal component DCT coefficients obtained from horizontal layer bit-plane VLD section 222 to generate a decoded horizontal component, and provides the generated component to band combining section 238.

Vertical layer input section 226 inputs a vertical layer stream. In other words, the section 226 receives the vertical layer stream from the outside of video decoding apparatus 200 to provide to vertical layer bit-plane VLD section 228.

Vertical layer bit-plane VLD section 228 performs the bit-plane VLD processing on the vertical layer stream. In other words, the section 228 performs the bit-plane VLD processing on the vertical layer stream obtained from vertical layer input section 226 to generate vertical component DCT coefficients, and provides the generated coefficients to vertical layer IDCT section 230.

Vertical layer IDCT section 230 performs the IDCT processing on the vertical component DCT coefficients. In other words, the section 230 performs the IDCT processing on the vertical component DCT coefficients obtained from vertical layer bit-plane VLD section 228 to generate a decoded vertical component, and provides the generated component to band combining section 238.

Diagonal layer input section 232 inputs a diagonal layer stream. In other words, the section 232 receives the diagonal layer stream from the outside of video decoding apparatus 200 to provide to diagonal layer bit-plane VLD section 234.

Diagonal layer bit-plane VLD section 234 performs the bit-plane VLD processing on the diagonal layer stream. In other words, the section 234 performs the bit-plane VLD processing on the diagonal layer stream obtained from diagonal layer input section 232 to generate diagonal component DCT coefficients, and provides the generated coefficients to diagonal layer IDCT section 236.

Diagonal layer IDCT section 236 performs the IDCT processing on the diagonal component DCT coefficients. In other words, the section 236 performs the IDCT processing on the diagonal component DCT coefficients obtained from diagonal layer bit-plane VLD section 234 to generate a decoded diagonal component, and provides the generated component to band combining section 238.

Band combining section 238 performs band combining and generates a high-resolution decoded image. In other words, the section 238 performs band combining on the middle-resolution decoded image obtained from adding section 216, the decoded horizontal component obtained from horizontal layer IDCT section 224, the decoded vertical component obtained from vertical layer IDCT section 230, and the decoded diagonal component obtained from diagonal layer IDCT section 236, and generates a high-resolution decoded image to provide to high-resolution video signal output section 240. The resolution of the high-resolution decoded image is equal to the resolution of the high-resolution original image subjected to coding.

Following equations 5 to 8 represent an example of the band combining method, and to combine band components subjected to band division using equations 1 to 4 as described earlier:
p[2x][2y]=a[x][y]−h[x][y]−v[x][y]−d[x][y] (Eq. 5)
p[2x+1][2y]=a[x][y]+h[x][y]−v[x][y]+d[x][y] (Eq. 6)
p[2x][2y+1]=a[x][y]−h[x][y]+v[x][y]+d[x][y] (Eq. 7)
p[2x+1][2y+1]=a[x][y]+h[x][y]+v[x][y]−d[x][y] (Eq. 8)
wherein “p” is a pixel value of the high-resolution decoded image, “a” is a pixel value of the middle-resolution decoded image, “h” is a pixel value of the decoded horizontal component, “v” is a pixel value of the decoded vertical component, “d” is a pixel value of the decoded diagonal component, and subscripts “x” and “y” are pixel values of coordinates (x,y).

In this band combining method, the high-resolution decoded image is divided into blocks each with four pixels where two pixels are aligned in either the vertical or horizontal direction, and is calculated from the middle-resolution decoded image and decoded horizontal, vertical and diagonal components corresponding to coordinates of the four pixels.

The “p” calculated in (Eq. 5) represents a pixel value of upper left, and is calculated by subtracting a sum of “h”, “v” and “d” from “a”. The “p” calculated in (Eq. 6) represents a pixel value of upper right, and is calculated by subtracting “v” from a sum of “a”, “h” and “d”. The “p” calculated in (Eq. 7) represents a pixel value of lower left, and is calculated by subtracting “h” from a sum of “a”, “v” and “d”. The “p” calculated in (Eq. 8) represents a pixel value of lower right, and is calculated by subtracting “d” from a sum of “a”, “h” and “v”.

In addition, when equations other than (Eq. 1) to (Eq. 4) are used in band division in coding, it is necessary to use a band combining method adapted to such equations.

High-resolution video signal output section 240 outputs the high-resolution decoded image to the outside of video decoding apparatus 200. In other words, the section 240 outputs the high-resolution decoded image obtained from band combining section 238 to the outside of video decoding apparatus 200.

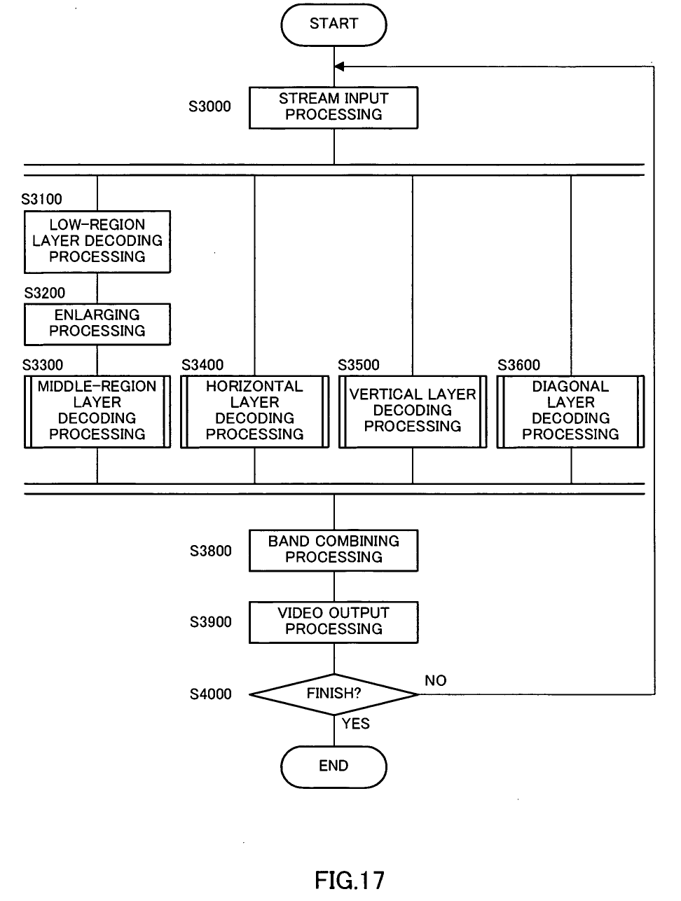

The operation of video decoding apparatus 200 with the configuration as described above will be described below with reference to a flowchart as shown in FIG. 17. The flowchart as shown in FIG. 17 is stored as a control program in a storage device (for example, such as ROM and flash memory), not shown, of video decoding apparatus 200, and executed by a CPU, not shown either.

First, in step S3000, stream input processing is carried out to input a stream. More specifically, low-region layer input section 202 receives the low-region layer stream from the outside of video decoding apparatus 200 to provide to low-region layer decoding section 204. Middle-region layer input section 210 receives the middle-region layer stream from the outside of video decoding apparatus 200 to provide to middle-region layer bit-plane VLD section 212. Horizontal layer input section 220 receives the horizontal layer stream from the outside of video decoding apparatus 200 to provide to horizontal layer bit-plane VLD section 222. Vertical layer input section 226 receives the vertical layer stream from the outside of video decoding apparatus 200 to provide to vertical layer bit-plane VLD section 228. Diagonal layer input section 232 inputs the diagonal layer stream receives the diagonal layer stream from the outside of video decoding apparatus 200 to provide to diagonal layer bit-plane VLD section 234.

Subsequently, processing of steps S3100 to S3300, and steps S3400, S3500, and S3600 is carried out in parallel.

In step S3100 is carried out low-region layer decoding processing to decode the low-region layer. More specifically, low-region layer decoding section 204 decodes the low-region layer stream obtained from low-region layer input section 202 to generate a low-resolution decoded image, and provides the generated image to low-resolution video signal output section 206 and enlarging section 208.

Then, in step S3200 is carried out enlarging processing to enlarge the low-resolution decoded image. More specifically, enlarging section 208 enlarges the low-resolution decoded image obtained from low-region layer decoding section 204 to generate an enlarged low-resolution decoded image, and provides the generated image to adding section 216.

In step S3300 is carried out middle-region layer decoding processing to decode the middle-region layer stream.

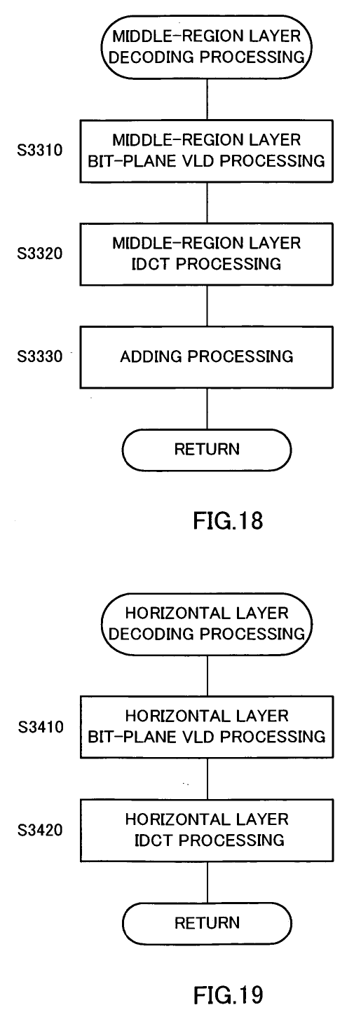

FIG. 18 is a flowchart illustrating an example of procedures of the middle-region layer decoding processing in FIG. 17.

First, in step S3310 is carried out middle-region layer bit-plane VLD processing. More specifically, middle-region layer bit-plane VLD section 212 performs the bit-plane VLD processing on the middle-region layer stream obtained from middle-region layer input section 210 to generate middle-region component DCT coefficients, and provides the generated coefficients to middle-region layer IDCT section 214.

In step S3320 is carried out middle-region layer IDCT processing. More specifically, middle-region layer IDCT section 214 performs the IDCT processing on the middle-region component DCT coefficients obtained from middle-region layer bit-plane VLD section 212 to generate a decoded differential image, and provides the decoded image to adding section 216.

In step S3330 is carried out adding processing. More specifically, adding section 216 adds the enlarged low-resolution decoded image obtained from enlarging section 208 and the decoded differential image obtained from middle-region layer IDCT section 214 to generate a middle-resolution decoded image, and provides the generated image to middle-resolution video signal output section 218 and band combining section 238. Then, the processing flow returns to the flowchart as shown in FIG. 17.

Meanwhile, in step S3400 is carried out horizontal layer decoding processing to decode the horizontal layer stream.

FIG. 19 is a flowchart illustrating an example of procedures of the horizontal layer decoding processing in FIG. 17.

First, in step S3410 is carried out horizontal layer bit-plane VLD processing. More specifically, horizontal layer bit-plane VLD section 222 performs the bit-plane VLD processing on the horizontal layer stream obtained from horizontal layer input section 220 to generate horizontal component DCT coefficients, and provides the generated coefficients to horizontal layer IDCT section 224.

In step S3420 is carried out horizontal layer IDCT processing. More specifically, horizontal layer IDCT section 224 performs the IDCT processing on the horizontal component DCT coefficients obtained from horizontal layer bit-plane VLD section 222 to generate a decoded horizontal component, and provides the decoded component to band combining section 238. Then, the processing flow returns to the flowchart as shown in FIG. 17.

Meanwhile, in step S3500 is carried out vertical layer decoding processing to decode the vertical layer stream.

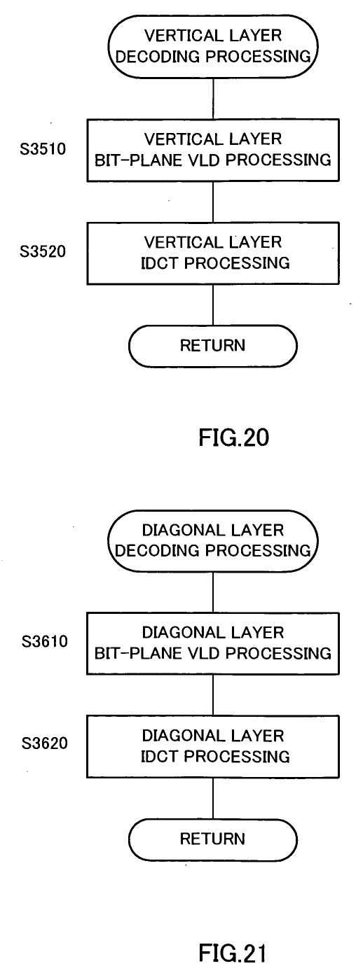

FIG. 20 is a flowchart illustrating an example of procedures of the vertical layer decoding processing in FIG. 17.

First, in step S3510 is carried out vertical layer bit-plane VLD processing. More specifically, vertical layer bit-plane VLD section 228 performs the bit-plane VLD processing on the vertical layer stream obtained from vertical layer input section 226 to generate vertical component DCT coefficients, and provides the generated coefficients to vertical layer IDCT section 230.

In step S3520 is carried out vertical layer IDCT processing. More specifically, vertical layer IDCT section 230 performs the IDCT processing on the vertical component DCT coefficients obtained from vertical layer bit-plane VLD section 228 to generate a decoded vertical component, and provides the decoded component to band combining section 238. Then, the processing flow returns to the flowchart as shown in FIG. 17.

Meanwhile, in step S3600 is carried out diagonal layer decoding processing to decode the diagonal layer stream.

FIG. 21 is a flowchart illustrating an example of procedures of the diagonal layer decoding processing in FIG. 17.

First, in step S3610 is carried out diagonal layer bit-plane VLD processing. More specifically, diagonal layer bit-plane VLD section 234 performs the bit-plane VLD processing on the diagonal layer stream obtained from diagonal layer input section 232 to generate diagonal component DCT coefficients, and provides the generated coefficients to diagonal layer IDCT section 236.

In step S3620 is carried out diagonal layer IDCT processing. More specifically, diagonal layer IDCT section 236 performs the IDCT processing on the diagonal component DCT coefficients obtained from diagonal layer bit-plane VLD section 234 to generate a decoded diagonal component, and provides the decoded component to band combining section 238. Then, the processing flow returns to the flowchart as shown in FIG. 17.

Subsequently, in step S3800 is carried out band combining processing. More specifically, band combining section 238 performs band combining on the middle-resolution decoded image obtained from adding section 216, the decoded horizontal component obtained from horizontal layer IDCT section 224, the decoded vertical component obtained from vertical layer IDCT section 230, and the decoded diagonal component obtained from diagonal layer IDCT section 236, for example, using (Eq. 5) to (Eq. 8) as described earlier, and generates a high-resolution decoded image to provide to high-resolution video signal output section 240.

In step S3900, video output processing is carried out to output the decoded image to the outside of video decoding apparatus 200. More specifically, low-resolution video signal output section 206 outputs the low-resolution decoded image obtained from low-region layer decoding section 204 to the outside of video decoding apparatus 200. Middle-resolution video signal output section 218 outputs the middle-resolution decoded image obtained from adding section 216 to the outside of video decoding apparatus 200. High-resolution video signal output section 240 outputs the high-resolution decoded image obtained from band combining section 238 to the outside of video decoding apparatus 200.

In step S4000, decoding finish determination processing is carried out to determine whether or not to finish a series of the video decoding processing. More specifically, for example, low-region layer input section 202 determines the presence or absence of a low-region layer stream to be input from the outside of video decoding apparatus 200, and determines that the decoding processing is continued (S4000: NO) when there is an input low-region layer stream, thereby returning to step S3000, while finishing a series of the video decoding processing when there is no input low-region layer stream (S4000: YES).

As described in the foregoing, in the video decoding, a plurality of video streams is decoded to generate decoded images respectively with low, middle and high resolutions.

Thus, according to this Embodiment, in video coding with resolution scalability, statistical predetermined bias occurs on the distribution of each DCT coefficients when video with the high resolution is subjected to band division, and thus generated horizontal, vertical and diagonal components are subjected to the DCT processing. Therefore, by determining a scanning method using the bias (statistical result), it is possible to perform coding efficiently.

Further, the video of high resolution is subjected to band division, and thus generated middle-resolution image is further separated into a low-region layer stream and middle-region layer stream to be coded, whereby it is possible to obtain the resolution scalability with total three stages.

Furthermore, since the scanning order to encode DCT coefficients of an 8×8 pixel block of each band component is varied corresponding to the bias (statistical result of the bias) of the band component, bits of “0” are biased toward to the latter half of scanning for each band component in scanning, the code length is thereby decreased, and it is possible to obtain high coding efficiency.

Moreover, since DCT coefficients of the horizontal, vertical and diagonal components are subjected to bit-plane coding processing, it is possible to obtain the image quality scalability, as well as the resolution scalability.

In addition, for example, in the case where absolute values of DCT coefficients of the band are approximated and the error is coded, it is possible to further reduce the information to code and obtain the high coding efficiency.

### Embodiment 2

This Embodiment describes a video coding method enabling image quality of high resolution to be improved efficiently, by encoding a plurality of band components to multiplex on a signal stream.

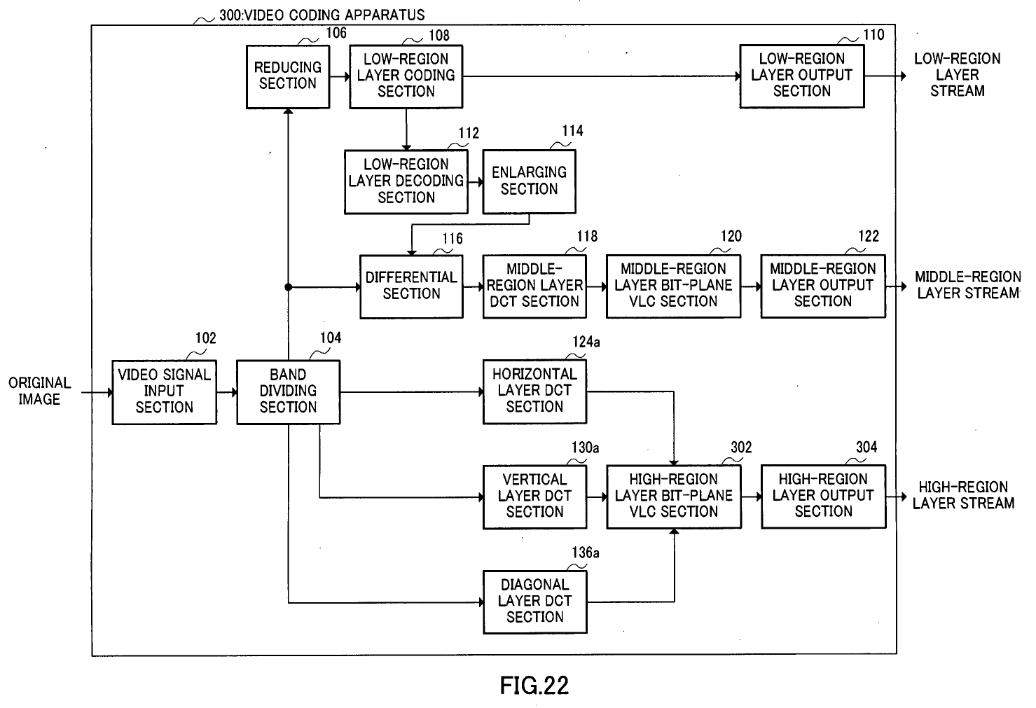

FIG. 22 is a block diagram illustrating a configuration of a video coding apparatus to which is applied a video coding method according to Embodiment 2 of the present invention. In addition, video coding apparatus 300 has a basic configuration similar to that of video coding apparatus 100 as shown in FIG. 2, and the same structural elements are assigned the same reference numerals to omit specific descriptions thereof.

It is a feature of this Embodiment to multiplex a horizontal, vertical and diagonal layer streams onto a signal stream. Therefore, substituting for horizontal layer bit-plane VLC section 126, horizontal layer output section 128, vertical layer bit-plane VLC section 132, vertical layer output section 134, diagonal layer bit-plane VLC section 138 and diagonal layer output section 140 in video coding apparatus 100 as shown in FIG. 2, video coding apparatus 300 has high-region layer bit-plane VLC section 302 and high-region layer output section 304. In addition, in this case, horizontal layer DCT section 124a obtains the horizontal component from band dividing section 104, performs the DCT processing on the obtained horizontal component on an 8×8 pixel block basis to generate horizontal component DCT coefficients, and provides the generated coefficients to high-region layer bit-plane VLC section 302. Further, vertical layer DCT section 130a obtains the vertical component from band dividing section 104, performs the DCT processing on the obtained vertical component on an 8×8 pixel block basis to generate vertical component DCT coefficients, and provides the generated coefficients to high-region layer bit-plane VLC section 302. Diagonal layer DCT section 136a obtains the diagonal component from band dividing section 104, performs the DCT processing on the obtained diagonal component on an 8×8 pixel block basis to generate diagonal component DCT coefficients, and provides the generated coefficients to high-region layer bit-plane VLC section 302.

High-region layer bit-plane VLC section 302 performs bit-plane coding on the horizontal, vertical and diagonal components subjected to the DCT processing to generate a high-region layer stream. In other words, the section 302 performs the bit-plane VLC processing on the horizontal component DCT coefficients obtained from horizontal layer DCT section 124a, the vertical component DCT coefficients obtained from vertical layer DCT section 130a, and the diagonal component DCT coefficients obtained from diagonal layer DCT section 136a sequentially for each bit position, and generates a high-region layer stream to provide to high-region layer output section 304.

High-region layer output section 304 outputs the high-region layer stream to the outside. In other words, the section 304 obtains the high-region layer stream from high-region layer bit-plane VLC section 302 to output to the outside of video coding apparatus 300.

Multiplexing will be described below that is the feature of the present invention.

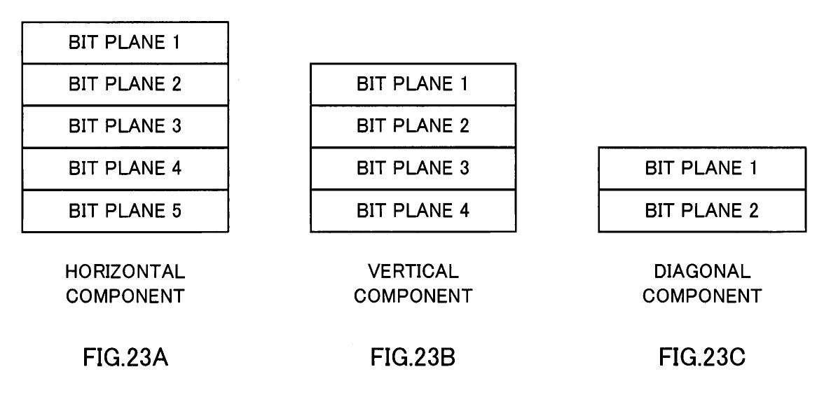

FIGS. 23A to 23C are schematic views respectively illustrating DCT coefficients of the horizontal component, vertical component and diagonal component. In each figure, bit plane 1 indicates a bit plane with the most significant bits, and as the number is decreased, the bit position is reduced. Irrespective of the band component, a bit plane with more significant bits exerts a greater effect on the image quality. For example, bit plane 1 of the vertical component exerts a greater effect on the image quality than that of bit plane 5 of the horizontal component.

Accordingly, when the amount of code of the horizontal, vertical and diagonal components is limited due to restrictions of transmission rate, regardless of the type of band component, coding preferentially a bit plane with more significant bits obtains high coding efficiency.

For example, using cases as shown in FIGS. 20A to 20C as an example, the order in which each band component subjected to the DCT processing is subjected to the bit-plane VLC processing and configured in a stream is as follows:
Horizontal 1;
Horizontal 2, Vertical 1;
Horizontal 3, Vertical 2;
Horizontal 4, Vertical 3, Diagonal 1; and
Horizontal 5, Vertical 4, Diagonal 2.
   Herein, for example, “Horizontal 1” represents bit plane 1 of the horizontal component, as an example.

In addition, in order to determine a component of the code of each bit plane in decoding, an identification signal is inserted for each bit plane. Further, since people have visual characteristics more sensitive to changes in horizontal, vertical and diagonal directions, in this order, when horizontal, vertical and diagonal components are stored in a stream in this order, it is possible to improve preferentially the image quality of the horizontal component that is visually sensitive even in the case where the transmission rate is limited.

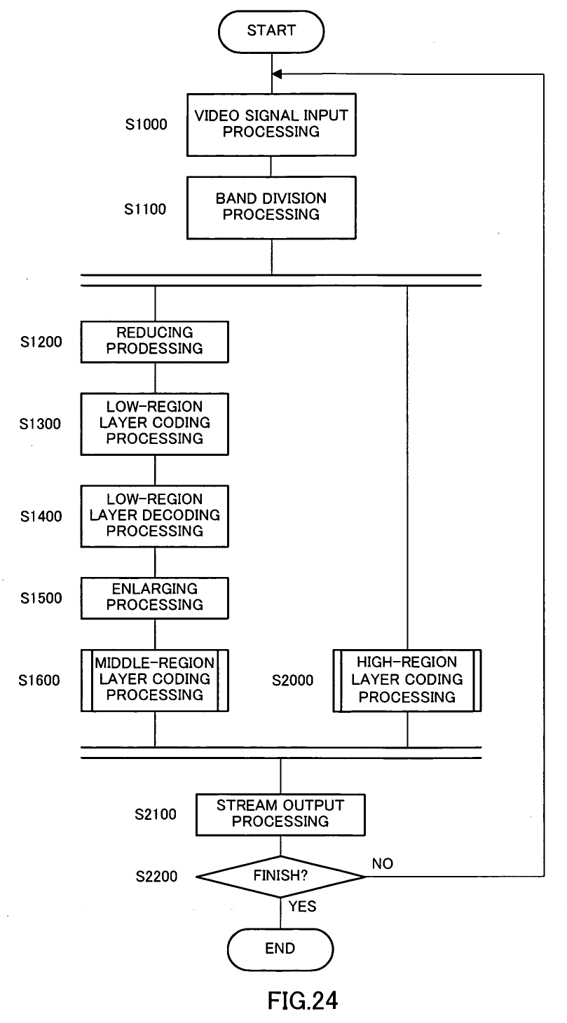

The operation of video coding apparatus 300 with the above-mentioned configuration will be described below with reference to a flowchart in FIG. 24. In addition, the flowchart as shown in FIG. 24 is stored as a control program in a storage device (for example, such as ROM and flash memory), not shown, of video coding apparatus 300, and executed by a CPU, not shown either.

In this Embodiment, as shown in FIG. 24, step S2000 is inserted into the flowchart as shown in FIG. 11, and steps S1700, S1800 and S1900 are eliminated.

Steps S1000 to S1600 are the same as those in the flowchart shown in FIG. 11, and descriptions thereof are omitted. In addition, in this Embodiment, when step S1100 is finished, the processing flow proceeds to step S1200 and step S2000.

Instep S2000 is carried out high-region layer coding processing to encode the high-region component.

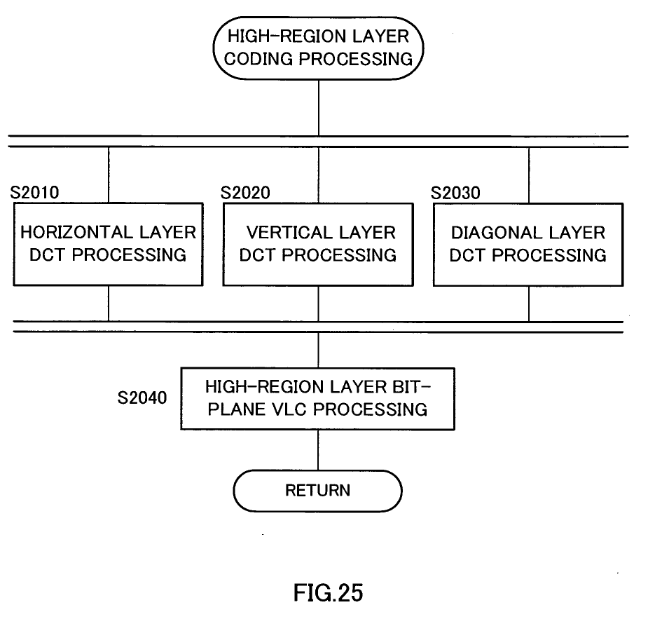

FIG. 25 is a flowchart illustrating an example of procedures of the high-region layer coding processing in FIG. 24. Herein, processing of steps S2010, S2020, S2030 is carried out in parallel.

In step S2010, the horizontal layer DCT processing is carried out to perform the DCT processing on the horizontal component. More specifically, horizontal layer DCT section 124a performs the DCT processing on the horizontal component obtained from band dividing section 104 to generate horizontal component DCT coefficients, and provides the generated coefficients to high-region layer bit-plane VLC section 302.

Meanwhile, in step S2020, the vertical layer DCT processing is carried out to perform the DCT processing on the vertical component. More specifically, vertical layer DCT section 130a performs the DCT processing on the vertical component obtained from band dividing section 104 to generate vertical component DCT coefficients, and provides the generated coefficients to high-region layer bit-plane VLC section 302.

In step S2030, the diagonal layer DCT processing is carried out to perform the DCT processing on the diagonal component. More specifically, diagonal layer DCT section 136a performs the DCT processing on the diagonal component obtained from band dividing section 104 to generate diagonal component DCT coefficients, and provides the generated coefficients to high-region layer bit-plane VLC section 302.

Subsequently, in step S2040, high-region layer bit-plane VLC processing is carried out to perform the bit-plane VLC processing on DCT coefficients of the horizontal, vertical and diagonal components. More specifically, high-region layer bit-plane VLC section 302 performs the bit-plane VLC processing on the horizontal component DCT coefficients obtained from horizontal layer DCT section 124a, the vertical component DCT coefficients obtained from vertical layer DCT section 130a, and the diagonal component DCT coefficients obtained from diagonal layer DCT section 136a sequentially for each bit plane, and generates a high-region layer stream to provide to high-region layer output section 304. Then, the processing flow returns to the flowchart as shown in FIG. 24.

Steps S2100 and S2200 are the same as those in the flowchart as shown in FIG. 11, and descriptions thereof are omitted. In this Embodiment, after finishing steps S1600 and S2000, the processing flow proceeds to step S2100. Further, in step S2100, low-region layer output section 110 outputs the low-region layer stream obtained from low-region layer coding section 108 to the outside of video coding apparatus 300. Middle-region layer output section 122 outputs the middle-region layer stream obtained from middle-region layer bit-plane VLC section 120 to the outside of video coding apparatus 300. High-region layer output section 304 outputs the high-region layer stream obtained from high-region layer bit-plane VLC section 302 to the outside of video coding apparatus 300.

A video decoding method will be described below to decode a video stream coded in this Embodiment.

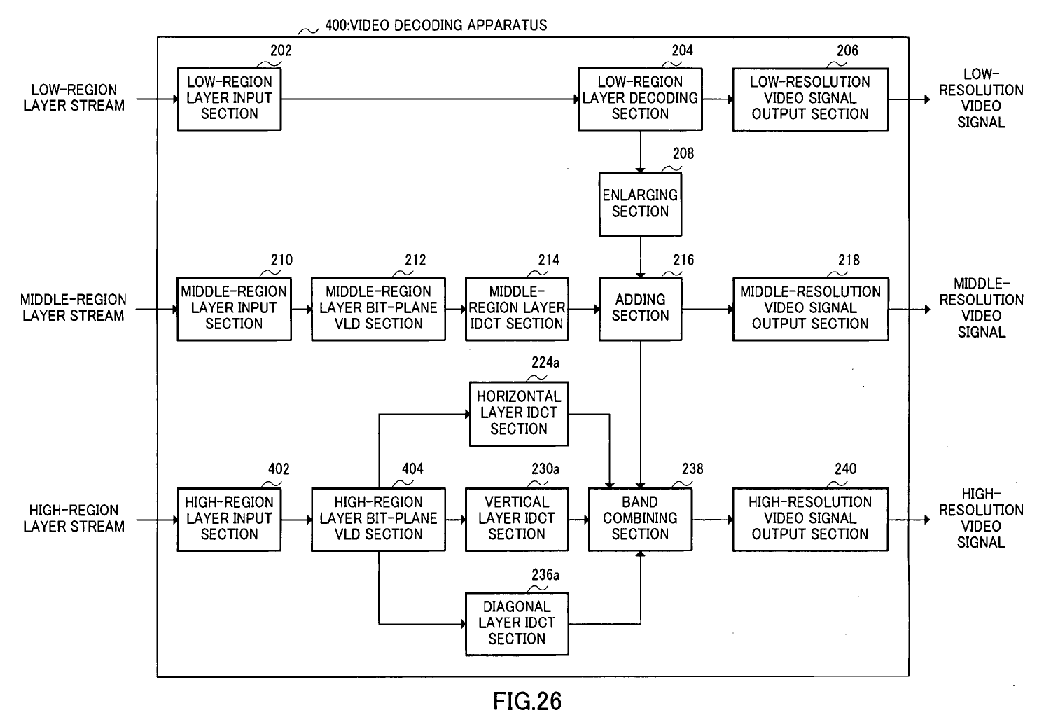

FIG. 26 is a block diagram illustrating a configuration of a video decoding apparatus to which is applied a video decoding method according to Embodiment 2 of the present invention. In addition, video decoding apparatus 400 has a basic configuration similar to that of video decoding apparatus 200 as shown in FIG. 16, and the same structural elements are assigned the same reference numerals to omit specific descriptions thereof.

Substituting for horizontal layer input section 220, horizontal layer bit-plane VLD section 222, vertical layer input section 226, vertical layer bit-plane VLD section 228, diagonal layer input section 232, and diagonal layer bit-plane VLD section 234 in video decoding apparatus 200 as shown in FIG. 16, video decoding apparatus 400 has high-region layer input section 402 and high-region layer bit-plane VLD section 404.

High-region layer input section 402 inputs the high-region layer stream. In other words, the section 402 receives the high-region layer stream from the outside of video decoding apparatus 400 to provide to high-region layer bit-plane VLD section 404.

High-region layer bit-plane VLD section 404 performs the bit-plane VLD processing on the high-region layer stream. In other words, the section 404 performs the bit-plane VLD processing on the high-region layer stream obtained from high-region layer input section 402 to generate horizontal, vertical and diagonal component DCT coefficients, and provides the horizontal component DCT coefficients to horizontal layer IDCT section 224a, the vertical component DCT coefficients to vertical layer IDCT section 230a, and the diagonal component DCT coefficients to diagonal layer IDCT section 236a.

Horizontal layer IDCT section 224a performs the IDCT processing on the horizontal component DCT coefficients obtained from high-region layer bit-plane VLD section 404 to generate a decoded horizontal component, and provides the generated component to band combining section 238. Vertical layer IDCT section 234a performs the IDCT processing on the vertical component DCT coefficients obtained from high-region layer bit-plane VLD section 404 to generate a decoded vertical component, and provides the generated component to band combining section 238. Diagonal layer IDCT section 236a performs the IDCT processing on the diagonal component DCT coefficients obtained from high-region layer bit-plane VLD section 404 to generate a decoded diagonal component, and provides the generated component to band combining section 238.

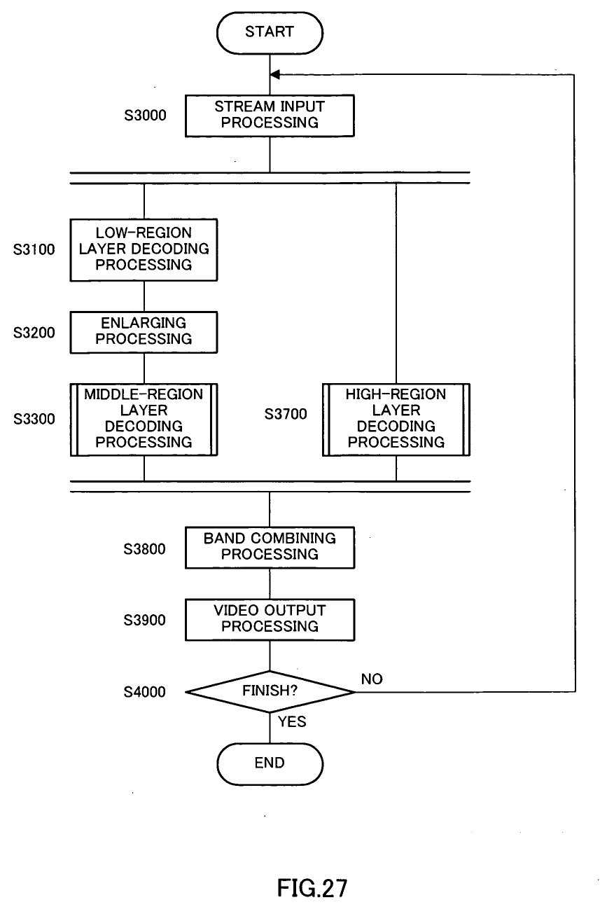

The operation of video decoding apparatus 400 with the configuration as described above will be described below with reference to a flowchart as shown in FIG. 27. The flowchart as shown in FIG. 27 is stored as a control program in a storage device (for example, such as ROM and flash memory), not shown, of video decoding apparatus 400, and executed by a CPU, not shown either.

In this Embodiment, as shown in FIG. 27, step S3700 is inserted into the flowchart as shown in FIG. 17, and steps S3400, S3500 and S3600 are eliminated.

Steps S3000 to S3300 are the same as those in the flowchart shown in FIG. 17, and descriptions thereof are omitted. In addition, in this Embodiment, when step S3000 is finished, the processing flow proceeds to step S3100 and step S3700. In step S3000, low-region layer input section 202 receives the low-region layer stream from the outside of video decoding apparatus 400 to provide to low-region layer decoding section 204. Middle-region layer input section 210 receives the middle-region layer stream from the outside of video decoding apparatus 400 to provide to middle-region layer bit-plane VLD section 212. High-region layer input section 210 receives the high-region layer stream from the outside of video decoding apparatus 400 to provide to high-region layer bit-plane VLD section 404.

In step S3700, high-region layer decoding processing is performed to decode the high-region layer.

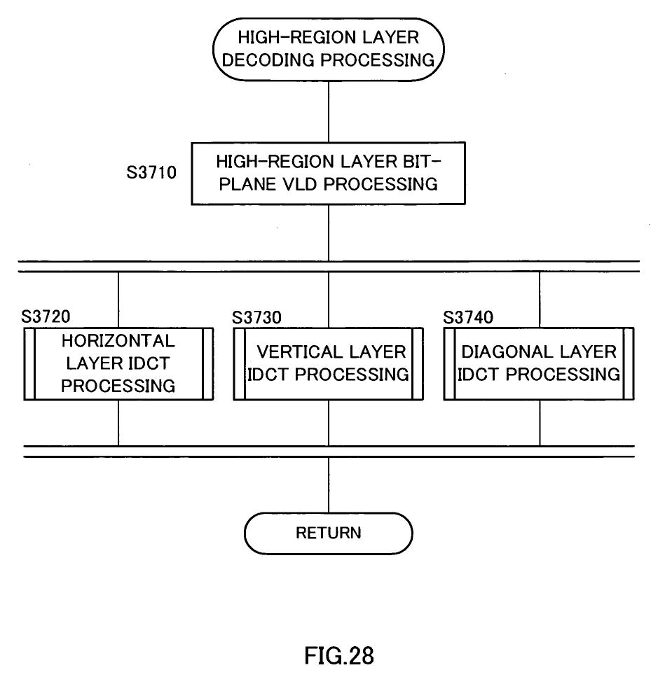

FIG. 28 is a flowchart illustrating an example of procedures of the high-region layer decoding processing in FIG. 27.

First, in step S3710, high-region layer bit-plane VLD processing is carried out to perform the bit-plane VLD processing on the high-region layer stream. More specifically, high-region layer bit-plane VLD section 404 performs the bit-plane VLD processing on the high-region layer stream obtained from high-region layer input section 402 to generate horizontal, vertical and diagonal component DCT coefficients, and provides the horizontal component DCT coefficients obtained to horizontal layer IDCT section 224a, the vertical component DCT coefficients to vertical layer IDCT section 230a, and the diagonal component DCT coefficients to diagonal layer IDCT section 236a.

Subsequently, the processing of steps S3720, S3730 and S3740 is carried out in parallel.

In step S3720, the horizontal layer IDCT processing is carried out to perform the IDCT processing on the horizontal component DCT coefficients. More specifically, horizontal layer IDCT section 224a performs the IDCT processing on the horizontal component DCT coefficients obtained from high-region layer bit-plane VLD section 404 to generate a decoded horizontal component, and provides the decoded component to band combining section 238.

Meanwhile, in step S3730, the vertical layer IDCT processing is carried out to perform the IDCT processing on the vertical component DCT coefficients. More specifically, vertical layer IDCT section 230a performs the IDCT processing on the vertical component DCT coefficients obtained from high-region layer bit-plane VLD section 404 to generate a decoded vertical component, and provides the decoded component to band combining section 238.

In step S3740, the diagonal layer IDCT processing is carried out to perform the IDCT processing on the diagonal component DCT coefficients. More specifically, diagonal layer IDCT section 236a performs the IDCT processing on the diagonal component DCT coefficients obtained from high-region layer bit-plane VLD section 404 to generate a decoded diagonal component, and provides the decoded component to band combining section 238.

Steps S3800 to S4000 are the same as those in the flowchart shown in FIG. 17, and descriptions thereof are omitted. In addition, in this Embodiment, when steps S3300 and S3700 are finished, the processing flow proceeds to step S3800.

Thus, according to this Embodiment, since the code of a bit plane of each band component is multiplexed and encoded, it is possible to improve the image quality efficiently.

In addition, in this Embodiment, the horizontal, vertical and diagonal layer streams are multiplexed onto a signal stream, but the present invention is not limited thereto, and allows the middle-region, horizontal, vertical and diagonal layer streams to be multiplexed onto a single stream.

### Embodiment 3

This Embodiment describes a fast video decoding method enabling selection of the resolution and image quality corresponding to the display resolution and processing capability of a video decoding apparatus and transmission rate.

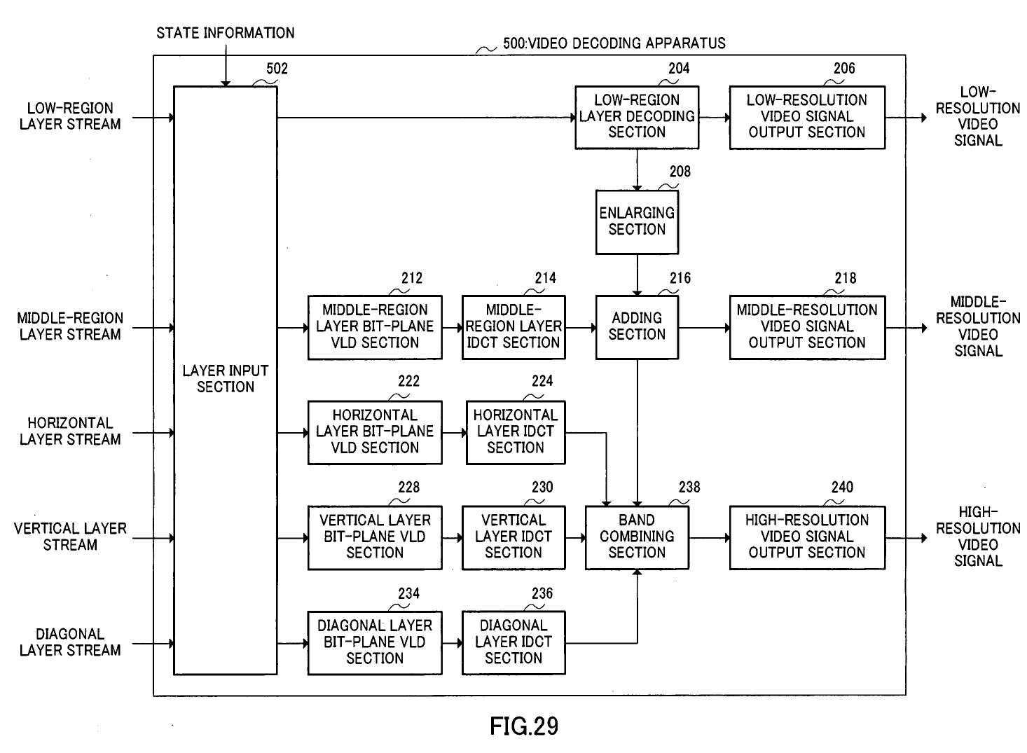

FIG. 29 is a block diagram illustrating a configuration of a video decoding apparatus to which is applied a video decoding method according to Embodiment 3 of the present invention. In addition, video decoding apparatus 500 has a basic configuration similar to that of video decoding apparatus 200 as shown in FIG. 16, and the same structural elements are assigned the same reference numerals to omit specific descriptions thereof.

It is a feature of this Embodiment to receive and decode a stream generated in video coding apparatus 100 of Embodiment 1 corresponding to the display resolution, processing capability and transmission rate. Therefore, substituting for low-region layer input section 202, middle-region layer input section 210, horizontal layer input section 220, vertical layer input section 226, and diagonal layer input section 232 in video decoding apparatus 200 as shown in FIG. 16, video decoding apparatus 500 has layer input section 502.

Layer input section 502 selects a stream to input and the amount of code to receive as its input. In other words, the section 502 obtains a state of video decoding apparatus 500 from the outside or inside of video decoding apparatus 500, selects a stream to receive and the amount of code of the stream to receive from among the low-region, middle-region, horizontal, vertical and diagonal layer streams based on the obtained state information, and receives the selected stream with the selected amount of code. Then, among the selected streams, the section 502 provides the low-region layer stream to low-region layer decoding section 204, the middle-region layer stream to middle-region layer bit-plane VLD section 212, the horizontal layer stream to horizontal layer bit-plane VLD section 222, the vertical layer stream to vertical layer bit-plane VLD section 228, and the diagonal layer stream to diagonal layer bit-plane VLD section 234.

Herein, the state of video decoding apparatus 500 includes the processing capability of video decoding apparatus 500, the resolution of a display device for a decoded image and transmission rate of the stream. Corresponding to these factors, the resolution is selected as described below:
(a) only a low-region layer stream is input;
(b) only a low-region and middle-region layer streams are input;
(c) only a low-region, middle-region and horizontal layer streams are input;
(d) only a low-region, middle-region and vertical layer streams are input;
(e) only a low-region, middle-region, horizontal and vertical layer streams are input; and
(f) all the low-region, middle-region, horizontal, vertical and diagonal layer streams are input:
   Since the middle-resolution and high-resolution images cannot be decoded unless the low-region layer is decoded, the input of the low-region layer is given the first priority. Further, by selecting the amount of each stream to be input to receive, it is possible to select the image quality corresponding to the processing capability of video decoding apparatus 500 and the transmission rate of the stream.

For example, specifically, a case is considered that streams can be decoded only in X % of the total amount of code except the low-region layer stream due to limitations in transmission rate of the streams. In this case, as a method of input, for example, following four examples are considered.

First, for example, the middle-region, horizontal, vertical and diagonal layers are input and decoded each with X/4% of the total amount of code.

Second, for example, X % of code of each of the middle-region, horizontal, vertical and diagonal layers is input and decoded.

Third, for example, the middle-region layer is input, the horizontal layer is then input after all the code of the middle-region layer is input, the vertical layer is then input after all the code of the horizontal layer is input, the diagonal layer is then input after all the code of the vertical layer is input, and thus, each layer is sequentially input and decoded. At the time the total amount of code reaches X %, the input is finished.

Fourth, for example, each layer is input and decoded corresponding to the ratio between the amounts of codes of generated middle-region, horizontal, vertical and diagonal layers.

In addition, low-region layer decoding section 204 obtains the low-region layer stream from layer input section 502, performs MPEG decoding on the obtained stream using predictive decoding, VLD, dequantization, IDCT, etc, generates a low-resolution decoded image, and provides the generated image to low-resolution video signal output section 206 and enlarging section 208. Middle-region layer bit-plane VLD section 212 performs bit-plane VLD processing on the middle-region layer stream obtained from layer input section 502 to generate middle-region component DCT coefficients, and provides the generated coefficients to middle-region layer IDCT section 214. Horizontal layer bit-plane VLD section 222 performs the bit-plane VLD processing on the horizontal layer stream obtained from layer input section 502 to generate horizontal component DCT coefficients, and provides the generated coefficients to horizontal layer IDCT section 224. Vertical layer bit-plane VLD section 228 performs the bit-plane VLD processing on the vertical layer stream obtained from layer input section 502 to generate vertical component DCT coefficients, and provides the generated coefficients to vertical layer IDCT section 230. Diagonal layer bit-plane VLD section 234 performs the bit-plane VLD processing on the diagonal layer stream obtained from layer input section 502 to generate diagonal component DCT coefficients, and provides the generated coefficients to diagonal layer IDCT section 236.

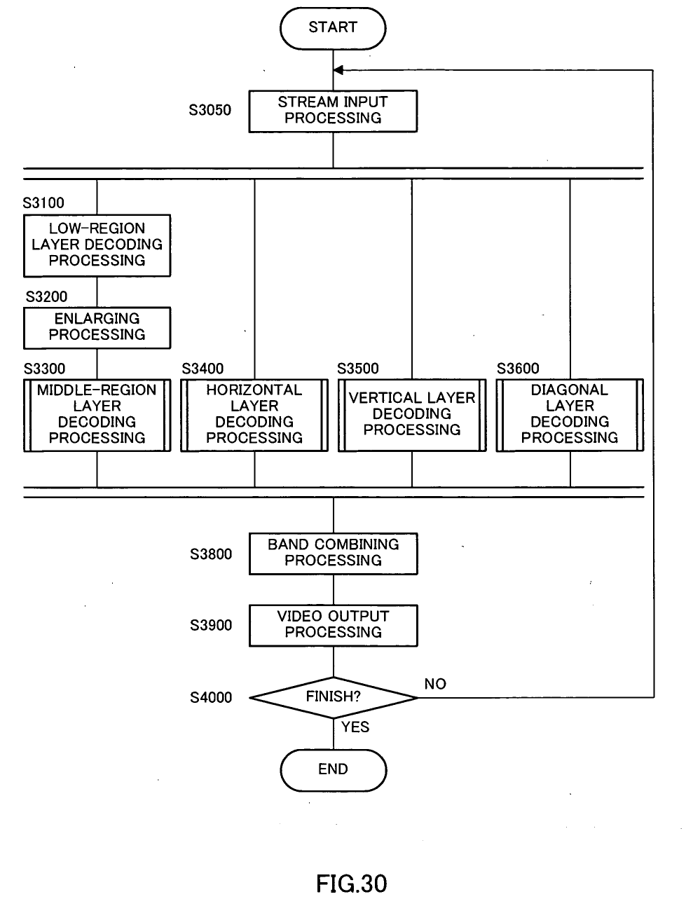

The operation of video decoding apparatus 500 with the configuration as described above will be described below with reference to a flowchart as shown in FIG. 30. The flowchart as shown in FIG. 30 is stored as a control program in a storage device (for example, such as ROM and flash memory), not shown, of video decoding apparatus 500, and executed by a CPU, not shown either.

In this Embodiment, as shown in FIG. 30, step S3050 is inserted into the flowchart as shown in FIG. 17, and step S3000 is eliminated.

In step S3050 is carried out stream input processing. More specifically, layer input section 502 obtains a state of video decoding apparatus 500 from the outside or inside of video decoding apparatus 500, selects a stream to be input and the amount of code of the input stream from among the low-region, middle-region, horizontal, vertical and diagonal layer streams based on the obtained state information, and receives the selected stream with the selected amount of code. Then, among the selected streams, the section 502 provides the low-region layer stream to low-region layer decoding section 204, the middle-region layer stream to middle-region layer bit-plane VLD section 212, the horizontal layer stream to horizontal layer bit-plane VLD section 222, the vertical layer stream to vertical layer bit-plane VLD section 228; and the diagonal layer stream to diagonal layer bit-plane VLD section 234.

Steps S3100 to S4000 are the same as those in the flowchart shown in FIG. 17, and descriptions thereof are omitted. In addition, in this Embodiment, in step S3100, low-region layer decoding section 204 obtains the low-region layer stream from layer input section 502. Instep S3410 (see FIG. 19) instep S3400, horizontal layer bit-plane VLD section 222 obtains the horizontal layer stream from layer input section 502. In step S3510 (see FIG. 20) in step S3500, vertical layer bit-plane VLD section 228 obtains the vertical layer stream from layer input section 502. In step S3610 (see FIG. 21) in step S3600, diagonal layer bit-plane VLD section 234 obtains the diagonal layer stream from layer input section 502.

Thus, according to this Embodiment, since a layer stream to decode is selected, it is possible to obtain the resolution scalability corresponding to a state of the video decoding apparatus.

Further, since the amount of code of a layer stream to decode is selected, it is possible to obtain the image quality scalability corresponding to a state of the video decoding apparatus.

Moreover, in this Embodiment, the target is a stream generated in video coding apparatus 100 in Embodiment 1. However, as a matter of course, by the same method, it is possible to receive a stream generated in video coding apparatus 300 in Embodiment 2 to decode, corresponding to the display resolution, processing capability and transmission rate.

### Embodiment 4

This Embodiment describes a case of performing quantization and VLC processing, instead of the bit-plane VLC processing. In the case of performing quantization and VLC processing, it is possible to obtain the same effects as in performing the bit-plane VLC processing. Further, in the case of performing quantization and VLC processing, the length of code is reduced using an EOB signal. In addition, scanning is also performed in the predetermined order during coding.

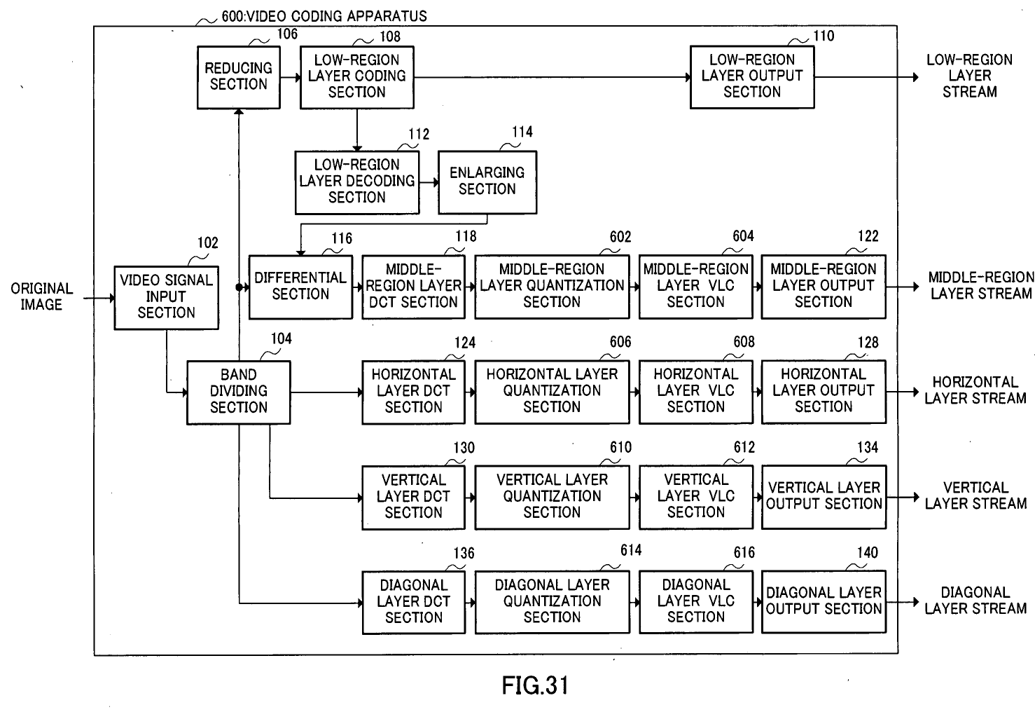

FIG. 31 is a block diagram illustrating a configuration of a video coding apparatus to which is applied a video coding method according to Embodiment 4 of the present invention. In addition, video coding apparatus 600 has a basic configuration similar to that of video coding apparatus 100 as shown in FIG. 2, and the same structural elements are assigned the same reference numerals to omit specific descriptions thereof.

It is a feature of this Embodiment to perform quantization and VLC processing, instead of the bit-plane VLC processing, in encoding the middle-region, horizontal, vertical and diagonal components. Therefore, substituting for middle-region layer bit-plane VLC section 120, horizontal layer bit-plane VLC section 126, vertical layer bit-plane VLC section 132 and diagonal layer bit-plane VLC section 138 in video coding apparatus 100 as shown in FIG. 2, video coding apparatus 600 has middle-region layer quantization section 602, middle-region layer VLC section 604, horizontal layer quantization section 606, horizontal layer VLC section 608, vertical layer quantization section 610, vertical layer VLC section 612, diagonal layer quantization section 612 and diagonal layer VLC section 616.

Middle-region layer quantization section 602 quantizes the middle-region component subjected to the DCT processing. In other words, the section 602 quantizes middle-region component DCT coefficients obtained form middle-region layer DCT section 118, and provides the quantized coefficients to middle-region layer VLC section 604.

Middle-region layer VLC section 604 performs the VLC processing on the quantized middle-region component DCT coefficients to generate a middle-region layer stream. In other words, the section 604 performs the VLC processing on the quantized middle-region component DCT coefficients obtained from middle-region layer quantization section 602 to generate a middle-region layer stream, and provides the generated stream to middle-region layer output section 122.

Horizontal layer quantization section 606 quantizes the horizontal component subjected to the DCT processing. In other words, the section 606 quantizes horizontal component DCT coefficients obtained form horizontal layer DCT section 124, and provides the quantized coefficients to horizontal layer VLC section 608.

Horizontal layer VLC section 608 performs the VLC processing on the quantized horizontal component DCT coefficients to generate a horizontal layer stream. In other words, the section 608 performs the VLC processing on the quantized horizontal component DCT coefficients obtained from horizontal layer quantization section 606 to generate a horizontal layer stream, and provides the generated stream to horizontal layer output section 128.

Vertical layer quantization section 610 quantizes the vertical component subjected to the DCT processing. In other words, the section 610 quantizes vertical component DCT coefficients obtained form vertical layer DCT section 130, and provides the quantized coefficients to vertical layer VLC section 612.

Vertical layer VLC section 612 performs the VLC processing on the quantized vertical component DCT coefficients to generate a vertical layer stream. In other words, the section 612 performs the VLC processing on the quantized vertical component DCT coefficients obtained from vertical layer quantization section 610 to generate a vertical layer stream, and provides the generated stream to vertical layer output section 134.

Diagonal layer quantization section 614 quantizes the diagonal component subjected to the DCT processing. In other words, the section 614 quantizes diagonal component DCT coefficients obtained form diagonal layer DCT section 136, and provides the quantized coefficients to diagonal layer VLC section 616.

Diagonal layer VLC section 616 performs the VLC processing on the quantized diagonal component DCT coefficients to generate a diagonal layer stream. In other words, the section 616 performs the VLC processing on the quantized diagonal component DCT coefficients obtained from diagonal layer quantization section 614 to generate a diagonal layer stream, and provides the generated stream to diagonal layer output section 140.

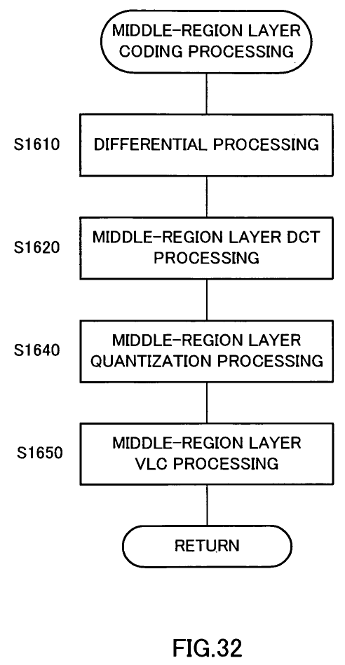

The operation of video coding apparatus 600 with the configuration as described above will be described with reference to flowcharts as shown in FIGS. 32 to 35. The flowcharts as shown in FIGS. 32 to 35 are stored as control programs in a storage device (for example, such as ROM and flash memory), not shown, of video coding apparatus 600, and executed by a CPU, not shown either.

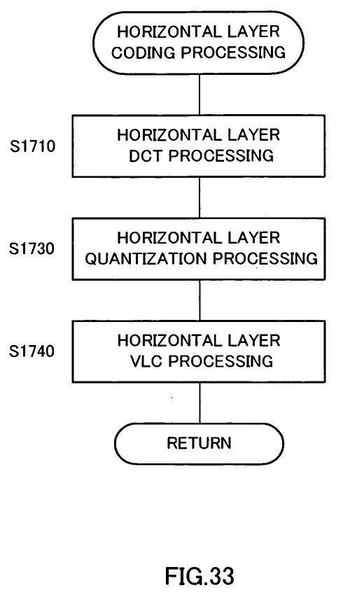

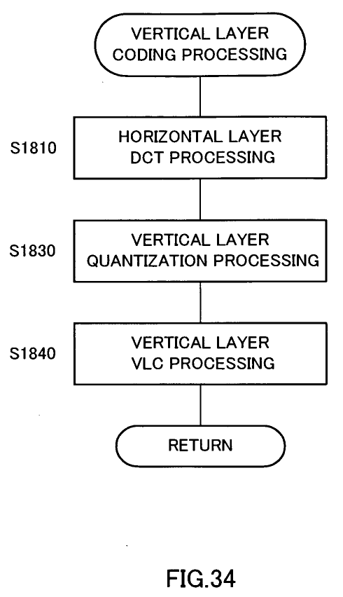

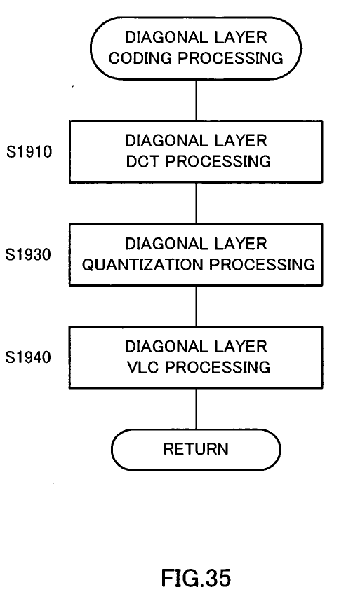

In this Embodiment, the main flowchart is the same as the flowchart shown in FIG. 11, and descriptions thereof are omitted. In this Embodiment, as shown FIG. 32, steps S1640 and S1650 are inserted into the flowchart as shown in FIG. 12, and step S1630 is eliminated. Further, as shown FIG. 33, steps S1730 and S1740 are inserted into the flowchart as shown in FIG. 13, and step S1720 is eliminated. Furthermore, as shown FIG. 34, steps S1830 and S1840 are inserted into the flowchart as shown in FIG. 14, and step S1820 is eliminated. Still furthermore, as shown FIG. 35, steps S1930 and S1940 are inserted into the flowchart as shown in FIG. 15, and step S1920 is eliminated.

In the middle-region layer coding processing as shown in FIG. 32, since steps S1610 and S1620 are the same as those in the flowchart shown in FIG. 12, descriptions thereof are omitted.

In step S1640 is carried out middle-region layer quantization processing. More specifically, middle-region layer quantization section 602 quantizes the middle-region component DCT coefficients obtained form middle-region layer DCT section 118, and provides the quantized coefficients to middle-region layer VLC section 604.

Then, in step S1650 is carried out middle-region layer VLC processing. More specifically, middle-region layer VLC section 604 performs the VLC processing on the quantized middle-region component DCT coefficients obtained from middle-region layer quantization section 602 to generate a middle-region layer stream, and provides the generated stream to middle-region layer output section 122. Subsequently, the processing flow returns to the flowchart as shown in FIG. 11.

In the horizontal layer coding processing as shown in FIG. 33, since step S1710 is the same as that in the flowchart shown in FIG. 13, descriptions thereof are omitted.

In step S1730 is carried out horizontal layer quantization processing. More specifically, horizontal layer quantization section 606 quantizes the horizontal component DCT coefficients obtained form horizontal layer DCT section 124, and provides the quantized coefficients to horizontal layer VLC section 608.

Then, in step S1740 is carried out horizontal layer VLC processing. More specifically, horizontal layer VLC section 608 performs the VLC processing on the quantized horizontal component DCT coefficients obtained from horizontal layer quantization section 606 to generate a horizontal layer stream, and provides the generated stream to horizontal layer output section 128. Subsequently, the processing flow returns to the flowchart as shown in FIG. 11.

In the vertical layer coding processing as shown in FIG. 34, since step S1810 is the same as that in the flowchart shown in FIG. 14, descriptions thereof are omitted.

In step S1830 is carried out vertical layer quantization processing. More specifically, vertical layer quantization section 610 quantizes the vertical component DCT coefficients obtained form vertical layer DCT section 130, and provides the quantized coefficients to vertical layer VLC section 612.

Then, in step S1840 is carried out vertical layer VLC processing. More specifically, vertical layer VLC section 612 performs the VLC processing on the quantized vertical component DCT coefficients obtained from vertical layer quantization section 610 to generate a vertical layer stream, and provides the generated stream to vertical layer output section 134. Subsequently, the processing flow returns to the flowchart as shown in FIG. 11.

In the diagonal layer coding processing as shown in FIG. 35, since step S1910 is the same as that in the flowchart shown in FIG. 15, descriptions thereof are omitted.

In step S1930 is carried out diagonal layer quantization processing. More specifically, diagonal layer quantization section 614 quantizes the diagonal component DCT coefficients obtained form diagonal layer DCT section 136, and provides the quantized coefficients to diagonal layer VLC section 616.

Then, in step S1940 is carried out diagonal layer VLC processing. More specifically, diagonal layer VLC section 616 performs the VLC processing on the quantized diagonal component DCT coefficients obtained from diagonal layer quantization section 614 to generate a diagonal layer stream, and provides the generated stream to diagonal layer output section 140. Subsequently, the processing flow returns to the flowchart as shown in FIG. 11.

A video decoding method will be described below to decode a video stream coded in this Embodiment.

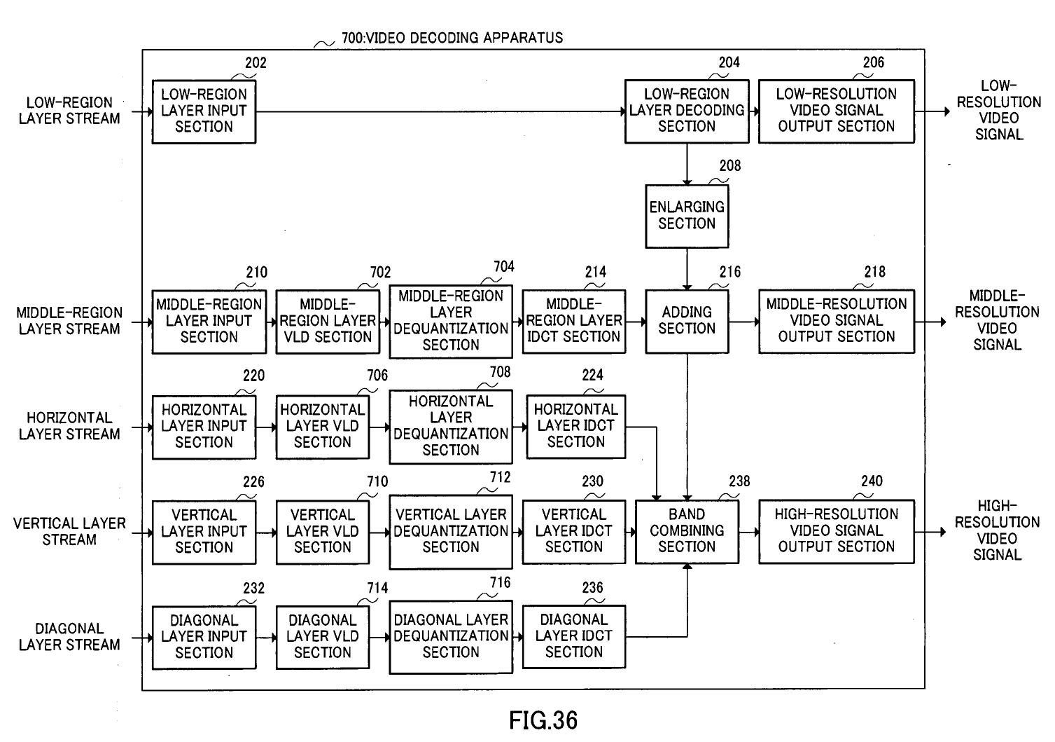

FIG. 36 is a block diagram illustrating a configuration of a video decoding apparatus to which is applied a video decoding method according to Embodiment 4 of the present invention. In addition, video decoding apparatus 700 has a basic configuration similar to that of video decoding apparatus 200 as shown in FIG. 16, and the same structural elements are assigned the same reference numerals to omit specific descriptions thereof.

Substituting for middle-region layer bit-plane VLD section 212, horizontal layer bit-plane VLD section 222, vertical layer bit-plane VLD section 228 and diagonal layer bit-plane VLD section 234 in video decoding apparatus 200 as shown in FIG. 16, video decoding apparatus 700 has middle-region layer VLD section 702, middle-region layer dequantization section 704, horizontal layer VLD section 706, horizontal layer dequantization section 708, vertical layer VLD section 710, vertical layer dequantization section 712, diagonal layer VLD section 714 and diagonal layer dequantization section 716.

Middle-region layer VLD section 702 performs VLD processing on the middle-region layer stream. In other words, the section 702 performs the VLD processing on the middle-region layer stream obtained from middle-region layer input section 210 to generate quantized middle-region component DCT coefficients, and provides the generated coefficients to middle-region layer dequantization section 704.

Middle-region layer dequantization section 704 dequantizes the quantized DCT coefficients of the middle-region component. In other words, the section 704 dequantizes the quantized middle-region component DCT coefficients obtained from middle-region layer VLD section 702, and generates non-quantized original middle-region component DCT coefficients to provide to middle-region layer IDCT section 214.

Horizontal layer VLD section 706 performs the VLD processing on the horizontal layer stream. In other words, the section 706 performs the VLD processing on the horizontal layer stream obtained from horizontal layer input section 220 to generate quantized horizontal component DCT coefficients, and provides the generated coefficients to horizontal layer dequantization section 708.

Horizontal layer dequantization section 708 dequantizes the quantized DCT coefficients of the horizontal component. In other words, the section 708 dequantizes the quantized horizontal component DCT coefficients obtained from horizontal layer VLD section 706, and generates non-quantized original horizontal component DCT coefficients to provide to horizontal layer IDCT section 224.

Vertical layer VLD section 710 performs the VLD processing on the vertical layer stream. In other words, the section 710 performs the VLD processing on the vertical layer stream obtained from vertical layer input section 226 to generate quantized vertical component DCT coefficients, and provides the generated coefficients to vertical layer dequantization section 712.

Vertical layer dequantization section 712 dequantizes the quantized DCT coefficients of the vertical component. In other words, the section 712 dequantizes the quantized vertical component DCT coefficients obtained from vertical layer VLD section 710, and generates non-quantized original vertical component DCT coefficients to provide to vertical layer IDCT section 230.

Diagonal layer VLD section 714 performs the VLD processing on the diagonal layer stream. In other words, the section 714 performs the VLD processing on the diagonal layer stream obtained from diagonal layer input section 232 to generate quantized diagonal component DCT coefficients, and provides the generated coefficients to diagonal layer dequantization section 716.

Diagonal layer dequantization section 716 dequantizes the quantized DCT coefficients of the diagonal component. In other words, the section 716 dequantizes the quantized diagonal component DCT coefficients obtained from diagonal layer VLD section 714, and generates non-quantized original diagonal component DCT coefficients to provide to diagonal layer IDCT section 236.

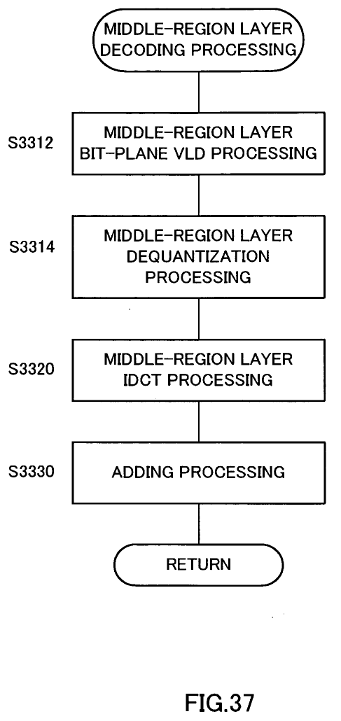

The operation of video decoding apparatus 700 with the configuration as described above will be described below with reference to flowcharts as shown in FIGS. 37 to 40. The flowcharts as shown in FIGS. 37 to 40 are stored as control programs in a storage device (for example, such as ROM and flash memory), not shown, of video decoding apparatus 700, and executed by a CPU, not shown either.

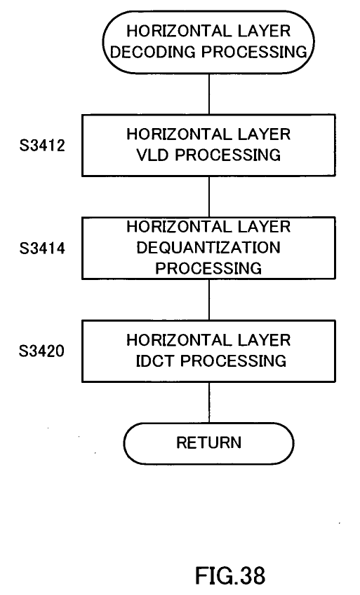

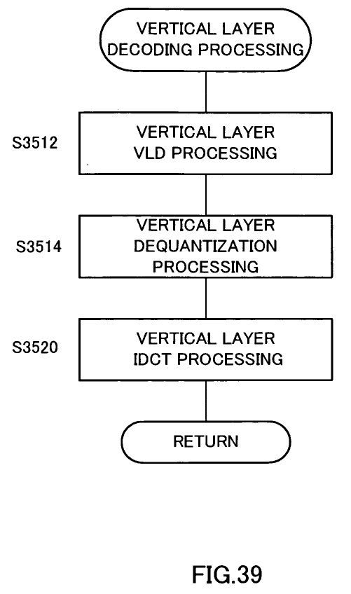

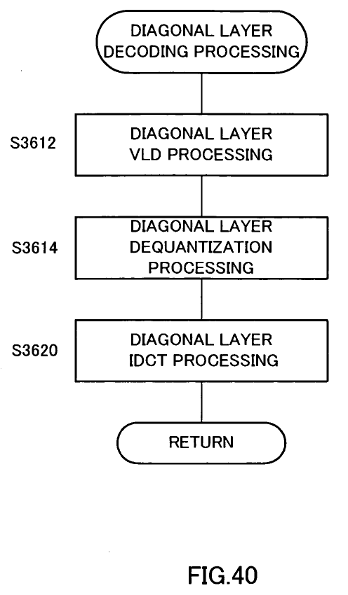

In this Embodiment, the main flowchart is the same as the flowchart shown in FIG. 17, and descriptions thereof are omitted. In this Embodiment, as shown FIG. 37, steps S3312 and S3314 are inserted into the flowchart as shown in FIG. 18, and step S3310 is eliminated. Further, as shown FIG. 38, steps S3412 and S3414 are inserted into the flowchart as shown in FIG. 19, and step S3410 is eliminated. Furthermore, as shown FIG. 39, steps S3512 and S3514 are inserted into the flowchart as shown in FIG. 20, and step S3510 is eliminated. Still furthermore, as shown FIG. 40, steps S3612 and S3614 are inserted into the flowchart as shown in FIG. 21, and step S3610 is eliminated.

In the middle-region layer decoding processing as shown in FIG. 37, in step S3312 is carried out middle-region layer VLD processing. More specifically, middle-region layer VLD section 702 performs the VLD processing on the middle-region layer stream obtained from middle-region layer input section 210 to generate quantized middle-region component DCT coefficients, and provides the generated coefficients to middle-region layer dequantization section 704.

Then, in step S3314 is carried out middle-region layer dequantization processing. More specifically, middle-region layer dequantization section 704 dequantizes the quantized middle-region component DCT coefficients obtained from middle-region layer VLD section 702, and generates non-quantized original middle-region component DCT coefficients to provide to middle-region layer IDCT section 214.

Steps S3320 and S3330 are the same as those in the flowchart shown in FIG. 18, and descriptions thereof are omitted.

In the horizontal layer decoding processing as shown in FIG. 38, in step S3412 is carried out horizontal layer VLD processing. More specifically, horizontal layer VLD section 706 performs the VLD processing on the horizontal layer stream obtained from horizontal layer input section 220 to generate quantized horizontal component DCT coefficients, and provides the generated coefficients to horizontal layer dequantization section 708.

Then, in step S3414 is carried out horizontal layer dequantization processing. More specifically, horizontal layer dequantization section 708 dequantizes the quantized horizontal component DCT coefficients obtained from horizontal layer VLD section 706, and generates non-quantized original horizontal component DCT coefficients to provide to horizontal layer IDCT section 224.

Step S3420 is the same as that in the flowchart shown in FIG. 19, and descriptions thereof are omitted.

In the vertical layer decoding processing as shown in FIG. 39, in step S3512 is carried out vertical layer VLD processing. More specifically, vertical layer VLD section 710 performs the VLD processing on the vertical layer stream obtained from vertical layer input section 226 to generate quantized vertical component DCT coefficients, and provides the generated coefficients to vertical layer dequantization section 712.

Then, in step S3514 is carried out vertical layer dequantization processing. More specifically, vertical layer dequantization section 710 dequantizes the quantized vertical component DCT coefficients obtained from vertical layer VLD section 710, and generates non-quantized original vertical component DCT coefficients to provide to vertical layer IDCT section 230.

Step S3520 is the same as that in the flowchart shown in FIG. 20, and descriptions thereof are omitted.

In the diagonal layer decoding processing as shown in FIG. 40, in step S3612 is carried out diagonal layer VLD processing. More specifically, diagonal layer VLD section 714 performs the VLD processing on the diagonal layer stream obtained from diagonal layer input section 232 to generate quantized diagonal component DCT coefficients, and provides the generated coefficients to diagonal layer dequantization section 716.

Then, in step S3614 is carried out diagonal layer dequantization processing. More specifically, diagonal layer dequantization section 716 dequantizes the quantized diagonal component DCT coefficients obtained from diagonal layer VLD section 714, and generates non-quantized original diagonal component DCT coefficients to provide to diagonal layer IDCT section 236.

Step S3620 is the same as that in the flowchart shown in FIG. 21, and descriptions thereof are omitted.

In this way, according to this Embodiment, substituting for bit-plane VLC, quantization and VLC is performed. Thus, by performing the VLC processing using a scanning method corresponding to the statistical result of the DCT processing associated with each band component after performing quantization, bits of “0” appear more frequently in the latter half of scanning, and for example, an EOB signal can be inserted earlier, whereby the length of code is reduced, and it is possible to obtain higher coding efficiency in combination with the quantization processing being high efficient.

As described above, according to the present invention, it is possible to implement the resolution scalability while improving the coding efficiency. That is,

(1) A video coding method of the present invention has a band dividing step of dividing a first-resolution image with the first resolution into a second-resolution image component with the second resolution lower than the first resolution and at least one of sub-band components including a horizontal component, a vertical component and a diagonal component, a DCT step of performing DCT processing on the divided sub-band component, and a coding step of coding the sub-band component subjected to the DCT processing using a scanning method corresponding to a statistical result of the DCT processing associated with each of the sub-band components.

According to this method, the DCT processing is performed on the sub-band component obtained by performing band division on the first-resolution image, and the DCT-processed sub-band component is encoded using the scanning method corresponding to a statistical result of the DCT processing associated with each of the sub-band components. It is thereby possible to generate a video stream enabling the resolution to be selected after coding, and to select the resolution by combining sub-band components. In other words, it is possible to achieve the resolution scalability.

Further, statistical predetermined bias occurs on the distribution of DCT coefficients of each sub-band component when the horizontal, vertical and diagonal components are subjected to the DCT processing. Therefore, by determining the scanning method (specifically, for example, scanning order and range) using the bias (statistical result), it is possible to perform coding efficiently. In other words, it is possible to implement the resolution scalability while improving the coding efficiency.

(2) A video coding method of the present invention further has the steps of, in the aforementioned method, reducing the second-resolution image to generate a third-resolution image with the third resolution lower than that of the second-resolution image, and generating a differential image between the second-resolution image and an enlarged image of the generated third-resolution image, where in the DCT step, the DCT processing is performed on the divided sub-band component and the generated differential image, and in the coding step, coding is performed on the sub-band component and the differential image each subjected to the DCT processing.

According to this method, since not only the sub-band component but also the differential image is subjected to the DCT processing and encoded, the number of resolutions to be selected increases corresponding to the increased number of streams, and it is thus possible to achieve the resolution scalability with finer granularity.

(3) In a video coding method of the present invention, in the coding step in the afore mentioned method, when the sub-band component subjected to the DCT processing is a horizontal component, DCT coefficients of the horizontal component are scanned from a vertical low frequency component to a vertical high frequency component, and thus the vertical low frequency component is preferentially encoded.

According to this method, noting the bias of the DCT coefficients of the horizontal component, the DCT coefficients of the horizontal component are scanned from the vertical low frequency component to the vertical high frequency component, whereby bits of “0” appear more frequently in the latter half of scanning in this scan. Therefore, for example, in the case of bit-plane VLC, an EOB (End Of Plane) signal can be inserted earlier, whereby the length of code is decreased and it is possible to achieve high coding efficiency.

(4) In a video coding method of the present invention, in the coding step in the above-mentioned method, when the sub-band component subjected to the DCT processing is a vertical component, DCT coefficients of the vertical component are scanned from a horizontal low frequency component to a horizontal high frequency component, and thus the horizontal low frequency component is preferentially encoded.

According to this method, noting the bias of the DCT coefficients of the vertical component, the DCT coefficients of the vertical component are scanned from the horizontal low frequency component to the horizontal high frequency component, whereby bits of “0” appear more frequently in the latter half of scanning in this scan. Therefore, for example, in the case of bit-plane VLC, an EOB signal can be inserted earlier, whereby the length of code is decreased and it is possible to achieve high coding efficiency.

(5) In a video coding method of the present invention, in the coding step in the above-mentioned method, when the sub-band component subjected to the DCT processing is a diagonal component, DCT coefficients of the diagonal component are scanned in a slanting direction from a horizontal high frequency and vertical high frequency component to a horizontal low frequency and vertical low frequency component, and thus the horizontal high frequency and vertical high frequency component is preferentially encoded.

According to this method, noting the bias of the DCT coefficients of the diagonal component, the DCT coefficients of the diagonal component are scanned in the slanting direction from the horizontal high frequency and vertical high frequency component to the horizontal low frequency and vertical low frequency component, whereby bits of “0” appear more frequently in the latter half of scanning in this scan. Therefore, for example, an EOB signal can be inserted earlier, whereby the length of code is decreased and it is possible to achieve high coding efficiency.

(6) In a video coding method of the present invention, in the coding step in the above-mentioned method, bit-plane VLC processing is performed on the sub-band component subjected to the DCT processing.

According to this method, since the bit-plane VLC processing is performed on the sub-band component subjected to the DCT processing, it is possible to control the amount of code to transmit on a frame-by-frame basis, i.e. selection of image quality is allowed, and it is possible to achieve both the resolution scalability and the image quality scalability.

(7) In a video coding method of the present invention, in the coding step in the above-mentioned method, a length of scanning is varied corresponding to a bit plane when the bit-plane VLC processing is performed on the sub-band component subjected to the DCT processing.

According to this method, the length of scanning is varied corresponding to a bit plane, in other words, the number of DCT coefficients is varied to perform variable length coding for each bit plane so as to encode a small number of DCT coefficients exerting a small effect on the image quality of a decoded image. For example, since scanning is reduced on a bit plane with less significant bits, coding is omitted on the less significant bits that are not important DCT components with a small effect on the image quality, and it is thus possible to achieve the high coding efficiency, while decreasing the length of variable length coding, resulting in fast processing (improvement in coding rate).

(8) In a video coding method of the present invention, in the coding step in the above-mentioned method, DCT coefficients of the sub-band component subjected to the DCT processing are approximated using a function to encode an error.

According to this method, noting the bias of the distribution of the DCT coefficients of each sub-band component, the DCT coefficients of each sub-band component are approximated using a function to encode an error. It is thereby possible to decrease the amount of information to encode and improve the coding efficiency.

(9) In a video coding method of the present invention, in the coding step in the above-mentioned method, each sub-band component subjected to the DCT processing is multiplexed onto a single stream for each bit plane in encoding the sub-band component subjected to the DCT processing.

According to this method, since each sub-band component is multiplexed onto a single stream for each bit plane, it is possible to improve the image quality efficiently.

(10) In a video coding method of the present invention, in the coding step in the above-mentioned method, when each sub-band component subjected to the DCT processing is multiplexed onto a single stream for each bit plane, multiplexing is performed preferentially on the horizontal component, the vertical component, and diagonal component, in this order.

According to this method, in the order of the horizontal component, the vertical component, and diagonal component, i.e. in descending order of sensitivity to human visual sense (in descending order of effect to objective image quality), sub-band components are given priorities to multiplex, and it is thus possible to improve the image quality efficiently.

(11) In a video coding method of the present invention, in the coding step in the above-mentioned method, quantization processing and VLC processing is performed on the sub-band component subjected to the DCT processing.

According to this method, since the quantization processing and VLC processing is performed on the sub-band component subjected to the DCT processing, by performing the VLC processing using a scanning method corresponding to a statistical result of the DCT processing associated with each sub-band component after performing the quantization processing, bits of “0” appear more frequently in the latter half of scanning in this scan, and it is possible to insert the EOB signal earlier, where by the length of code is decreased and it is possible to achieve higher coding efficiency in combination with the quantization processing being high efficient.

(12) A video decoding method of the present invention has a decoding step of decoding a stream of each sub-band component generated in the video coding method as described in above-mentioned item (1), an inverse DCT step of performing inverse DCT processing on the each decoded sub-band component, and a combining step of combining each sub-band component subjected to the inverse DCT processing.

According to this method, since a stream of each sub-band component generated in the video coding method as described in item (1) is decoded, subjected to the inverse DCT processing, and combined, it is possible to achieve the resolution scalability in combination with to the video coding method as described in item (1).

(13) A video decoding method of the present invention further has, in the aforementioned method, a selecting step of selecting a stream to decode based on predetermined information, and in the decoding step, the selected stream is decoded.

According to this method, since a stream to decode is selected based on the predetermined information, it is possible to select the resolution, for example, corresponding to a state (processing capability, resolution of a display device, transmission rate, etc.) of a video decoding apparatus.

(14) A video decoding method of the present invention further has, in the aforementioned method, a selecting step of selecting an amount of code of a stream to decode based on predetermined information, and in the decoding step, the stream with the selected amount of code is decoded.

According to this method, since the amount of code of a stream to decode is selected based on the predetermined information, it is possible to select the image quality in some resolution, for example, corresponding to a state (processing capability, resolution of a display device, transmission rate, etc.) of a video decoding apparatus.

The video coding method according to the present invention enables the resolution and image quality to be selected, and therefore, is useful as a video stream distribution coding method for providing the resolution and the amount of code in accordance with the transmission rate, terminal processing capability and/or display area on the Internet, etc.

Further, since it is possible to select the resolution and image quality to vary the amount of transmission finely, the video coding method can be applied as a coding method to transmit video flexibility in response to variation in band of communications using radio signals.

Furthermore, since fast coding is allowed, for example, the video coding method can be applied as a real-time broadcast distribution coding method for terminals with different display resolutions such as a large-screen television and portable terminal on TV broadcast.

Moreover, since it is possible to vary the resolution and/or image quality even after coding to reduce the storage capability adaptively, for example, the video coding method can be applied as a coding method for storage of video of a security monitor camera and for storage of entertainment video distribution.

The present invention is not limited to the above described Embodiments, and various variations and modifications may be possible without departing from the scope of the present invention.

This application is based on the Japanese Patent Application No. 2003-346272 filed on Oct. 3, 2003, entire content of which is expressly incorporated by reference herein.

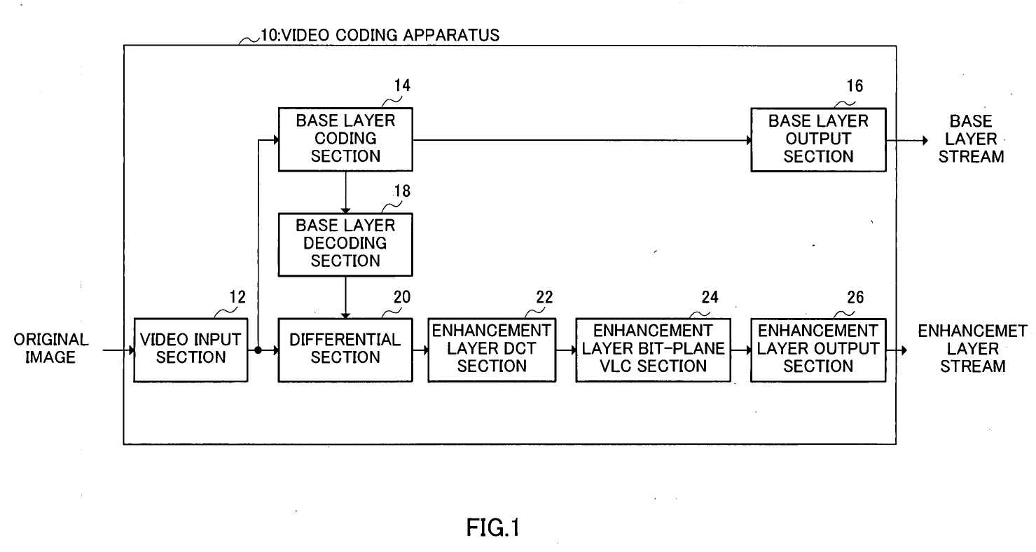

FIG. 1

10 VIDEO CODING APPARATUS

ORIGINAL IMAGE

12 VIDEO INPUT SECTION

14 BASE LAYER CODING SECTION

16 BASE LAYER OUTPUT SECTION

BASE LAYER STREAM

18 BASE LAYER DECODING SECTION

20 DIFFERENTIAL SECTION

22 ENHANCEMENT LAYER DCT SECTION

24 ENHANCEMENT LAYER BIT-PLANE VLC SECTION

26 ENHANCEMENT LAYER OUTPUT SECTION

ENHANCEMENT LAYER STREAM

FIG. 2 FIG. 22 FIG. 31

100 VIDEO CODING APPARATUS

102 VIDEO SIGNAL INPUT SECTION

ORIGINAL IMAGE

104 BAND DIVIDING SECTION

106 REDUCING SECTION

108 LOW-REGION LAYER CODING SECTION

110 LOW-REGION LAYER OUTPUT SECTION

LOW-REGION LAYER STREAM

112 LOW-REGION LAYER DECODING SECTION

114 ENLARGING SECTION

116 DIFFERENTIAL SECTION

118 MIDDLE-REGION LAYER DCT SECTION

120 MIDDLE-REGION LAYER BIT-PLANE VLC SECTION

122 MIDDLE-REGION LAYER OUTPUT SECTION

MIDDLE-REGION LAYER STREAM

124 HORIZONTAL LAYER DCT SECTION

126 HORIZONTAL LAYER BIT-PLANE VLC SECTION

128 HORIZONTAL LAYER OUTPUT SECTION

HORIZONTAL LAYER STREAM

130 VERTICAL LAYER DCT SECTION

132 VERTICAL LAYER BIT-PLANE VLC SECTION

134 VERTICAL LAYER OUTPUT SECTION

VERTICAL LAYER STREAM

136 DIAGONAL LAYER DCT SECTION

138 DIAGONAL LAYER BIT-PLANE VLC SECTION

140 DIAGONAL LAYER OUTPUT SECTION

DIAGONAL LAYER STREAM

FIG. 3A

ORIGINAL IMAGE

FIG. 3B

MIDDLE-RESOLUTION IMAGE

HORIZONTAL COMPONENT

VERTICAL COMPONENT

DIAGONAL COMPONENT

FIG. 3C

LOW-RESOLUTION IMAGE

FIG. 4 FIG. 5 FIG. 6 FIG. 7 FIG. 8

DCT COEFFICIENT

VERTICAL FREQUENCY

HORIZONTAL FREQUENCY

FIG. 4A MIDDLE-RESOLUTION IMAGE

FIG. 4B HORIZONTAL COMPONENT

FIG. 4C VERTICAL COMPONENT

FIG. 4D DIAGONAL COMPONENT

FIG. 9

BIT PLANE

FIG. 10

DCT COEFFICIENT

VERTICAL FREQUENCY

FIG. 11 FIG. 24

START

S1000 VIDEO SIGNAL INPUT PROCESSING

S1100 BAND DIVISION PROCESSING

S1200 REDUCING PROCESSING

S1300 LOW-REGION LAYER CODING PROCESSING

S1400 LOW-REGION LAYER DECODING PROCESSING

S1500 ENLARGING PROCESSING

S1600 MIDDLE-REGION LAYER CODING PROCESSING

S1700 HORIZONTAL LAYER CODING PROCESSING

S1800 VERTICAL LAYER CODING PROCESSING

S1900 DIAGONAL LAYER CODING PROCESSING

S2100 STREAM OUTPUT PROCESSING

S2200 FINISH?

END

FIG. 12 FIG. 32

MIDDLE-REGION LAYER CODING PROCESSING

S1610 DIFFERENTIAL PROCESSING

S1620 MIDDLE-REGION LAYER DCT PROCESSING

S1630 MIDDLE-REGION LAYER BIT-PLANE VLC PROCESSING

RETURN

FIG. 13 FIG. 33

HORIZONTAL LAYER CODING PROCESSING

S1710 HORIZONTAL LAYER DCT PROCESSING

S1720 HORIZONTAL LAYER BIT-PLANE VLC PROCESSING

RETURN

FIG. 14 FIG. 34

VERTICAL LAYER CODING PROCESSING

S1810 VERTICAL LAYER DCT PROCESSING

S1820 VERTICAL LAYER BIT-PLANE VLC PROCESSING

RETURN

FIG. 15 FIG. 35

DIAGONAL LAYER CODING PROCESSING

S1910 DIAGONAL LAYER DCT PROCESSING

S1920 DIAGONAL LAYER BIT-PLANE VLC PROCESSING

RETURN

FIG. 16 FIG. 25 FIG. 29 FIG. 36

200 VIDEO DECODING APPARATUS

202 LOW-REGION LAYER INPUT SECTION

LOW-REGION LAYER STREAM

204 LOW-REGION LAYER DECODING SECTION

206 LOW-RESOLUTION VIDEO SIGNAL OUTPUT SECTION

LOW-RESOLUTION VIDEO SIGNAL

208 ENLARGING SECTION

210 MIDDLE-REGION LAYER INPUT SECTION

MIDDLE-REGION LAYER STREAM

212 MIDDLE-REGION LAYER BIT-PLANE VLD SECTION

214 MIDDLE-REGION LAYER IDCT SECTION

216 ADDING SECTION

218 MIDDLE-RESOLUTION VIDEO SIGNAL OUTPUT SECTION

MIDDLE-RESOLUTION VIDEO SIGNAL

220 HORIZONTAL LAYER INPUT SECTION

HORIZONTAL LAYER STREAM

222 HORIZONTAL LAYER BIT-PLANE VLD SECTION

224 HORIZONTAL LAYER IDCT SECTION

226 VERTICAL LAYER INPUT SECTION

VERTICAL LAYER STREAM

228 VERTICAL LAYER BIT-PLANE VLD SECTION

230 VERTICAL LAYER IDCT SECTION

232 DIAGONAL LAYER INPUT SECTION

DIAGONAL LAYER STREAM

234 DIAGONAL LAYER BIT-PLANE VLD SECTION

236 DIAGONAL LAYER IDCT SECTION

238 BAND COMBINING SECTION

240 HIGH-RESOLUTION VIDEO SIGNAL OUTPUT SECTION

HIGH-RESOLUTION VIDEO SIGNAL

FIG. 17 FIG. 27 FIG. 30

START

S3000 STREAM INPUT PROCESSING

S3100 LOW-REGION LAYER DECODING PROCESSING

S3200 ENLARGING PROCESSING

S3300 MIDDLE-REGION LAYER DECODING PROCESSING

S3400 HORIZONTAL LAYER DECODING PROCESSING

S3500 VERTICAL LAYER DECODING PROCESSING

S3600 DIAGONAL LAYER DECODING PROCESSING

S3800 BAND COMBINING PROCESSING

S3900 VIDEO OUTPUT PROCESSING

S4000 FINISH?

END

FIG. 18 FIG. 37

MIDDLE-REGION LAYER DECODING PROCESSING

S3310 MIDDLE-REGION LAYER BIT-PLANE VLD PROCESSING

S3320 MIDDLE-REGION LAYER IDCT PROCESSING

S3330 ADDING PROCESSING

RETURN

FIG. 19 FIG. 38

HORIZONTAL LAYER DECODING PROCESSING

S3410 HORIZONTAL LAYER BIT-PLANE VLD PROCESSING

S3420 HORIZONTAL LAYER IDCT PROCESSING

RETURN

FIG. 20 FIG. 39

VERTICAL LAYER DECODING PROCESSING

S3510 VERTICAL LAYER BIT-PLANE VLD PROCESSING

S3520 VERTICAL LAYER IDCT PROCESSING

RETURN

FIG. 21 FIG. 40

DIAGONAL LAYER DECODING PROCESSING

S3610 DIAGONAL LAYER BIT-PLANE VLD PROCESSING

S3620 DIAGONAL LAYER IDCT PROCESSING

RETURN

FIG. 22

300 VIDEO CODING APPARATUS

302 HIGH-REGION LAYER BIT-PLANE VLC SECTION

304 HIGH-REGION LAYER OUTPUT SECTION

HIGH-REGION LAYER STREAM

FIG. 23

BIT PLANE

FIG. 22A HORIZONTAL COMPONENT

FIG. 22B VERTICAL COMPONENT

FIG. 22C DIAGONAL COMPONENT

FIG. 24

S2000 HIGH-REGION LAYER CODING PROCESSING

S2100 STREAM OUTPUT PROCESSING

S2200 FINISH?

FIG. 25

HIGH-REGION LAYER CODING PROCESSING

S2010 HORIZONTAL LAYER DCT PROCESSING

S2020 VERTICAL LAYER DCT PROCESSING

S2030 DIAGONAL LAYER DCT PROCESSING

S2040 HIGH-REGION LAYER BIT-PLANE VLC PROCESSING

FIG. 26

400 VIDEO DECODING APPARATUS

224a HORIZONTAL LAYER IDCT SECTION

230a VERTICAL LAYER IDCT SECTION

236a DIAGONAL LAYER IDCT SECTION

402 HIGH-REGION LAYER INPUT SECTION

HIGH-REGION LAYER STREAM

404 HIGH-REGION LAYER BIT-PLANE VLD SECTION

HIGH-RESOLUTION VIDEO SIGNAL

FIG. 27

S3700 HIGH-REGION LAYER DECODING PROCESSING

FIG. 28

HIGH-REGION LAYER DECODING PROCESSING

S3710 HIGH-REGION LAYER BIT-PLANE VLD PROCESSING

S3720 HORIZONTAL LAYER IDCT PROCESSING

S3730 VERTICAL LAYER IDCT PROCESSING

S3740 DIAGONAL LAYER IDCT PROCESSING

RETURN

FIG. 29

500 VIDEO DECODING APPARATUS

502 LAYER INPUT SECTION

STATE INFORMATION

FIG. 30

S3050 STREAM INPUT PROCESSING

FIG. 31

600 VIDEO CODING APPARATUS

602 MIDDLE-REGION LAYER QUANTIZATION SECTION

604 MIDDLE-REGION LAYER VLC SECTION

606 HORIZONTAL LAYER QUANTIZATION SECTION

608 HORIZONTAL LAYER VLC SECTION

610 VERTICAL LAYER QUANTIZATION SECTION

612 VERTICAL LAYER VLC SECTION

614 DIAGONAL LAYER QUANTIZATION SECTION

616 DIAGONAL LAYER VLC SECTION

FIG. 32

S1640 MIDDLE-REGION LAYER QUANTIZATION PROCESSING

S1650 MIDDLE-REGION LAYER VLC PROCESSING

FIG. 33

S1730 HORIZONTAL LAYER QUANTIZATION PROCESSING

S1740 HORIZONTAL LAYER VLC PROCESSING

FIG. 34

S1830 VERTICAL LAYER QUANTIZATION PROCESSING

S1840 VERTICAL LAYER VLC PROCESSING

FIG. 35

S1930 DIAGONAL LAYER QUANTIZATION PROCESSING

S1940 DIAGONAL LAYER VLC PROCESSING

FIG. 36

700 VIDEO DECODING APPARATUS

702 MIDDLE-REGION LAYER VLD SECTION

704 MIDDLE-REGION LAYER DEQUANTIZATION SECTION

706 HORIZONTAL LAYER VLD SECTION

708 HORIZONTAL LAYER DEQUANTIZATION SECTION

710 VERTICAL LAYER VLD SECTION

712 VERTICAL LAYER DEQUANTIZATION SECTION

714 DIAGONAL LAYER VLD SECTION

716 DIAGONAL LAYER DEQUANTIZATION SECTION

FIG. 37

S3312 MIDDLE-REGION LAYER VLD PROCESSING

S3314 MIDDLE-REGION LAYER DEQUANTIZATION PROCESSING

FIG. 38

S3412 HORIZONTAL LAYER VLD PROCESSING

S3414 HORIZONTAL LAYER DEQUANTIZATION PROCESSING

FIG. 39

S3512 VERTICAL LAYER VLD PROCESSING

S3514 VERTICAL LAYER DEQUANTIZATION PROCESSING

FIG. 40

S3612 DIAGONAL LAYER VLD PROCESSING

S3614 DIAGONAL LAYER DEQUANTIZATION PROCESSING

1. A video coding method comprising:
a band dividing step of dividing a first-resolution image with a first resolution into a second-resolution image component with a second resolution lower than the first resolution and at least one of sub-band components including a horizontal component, a vertical component and a diagonal component;
a DCT step of performing DCT (Discrete Cosine Transform) processing on a divided sub-band component; and
a coding step of coding the sub-band component subjected to the DCT processing using a scanning method corresponding to a statistical result of the DCT processing associated with each of the sub-band components.

2. The video coding method according to claim 1, further comprising the steps of:
reducing the second-resolution image to generate a third-resolution image with a third resolution lower than the second resolution of the second-resolution image; and
generating a differential image between the second-resolution image and an enlarged image of the third-resolution image generated,
wherein in the DCT step, the DCT processing is performed on the divided sub-band component and the differential image generated, and in the coding step, coding is performed on the sub-band component and the differential image each subjected to the DCT processing.

3. The video coding method according to claim 1, wherein in the coding step, when the sub-band component subjected to the DCT processing is the horizontal component, DCT coefficients of the horizontal component are scanned from a vertical low frequency component to a vertical high frequency component, and thus the vertical low frequency component is preferentially encoded.

4. The video coding method according to claim 1, wherein in the coding step, when the sub-band component subjected to the DCT processing is the vertical component, DCT coefficients of the vertical component are scanned from a horizontal low frequency component to a horizontal high frequency component, and thus the horizontal low frequency component is preferentially encoded.

5. The video coding method according to claim 1, wherein in the coding step, when the sub-band component subjected to the DCT processing is the diagonal component, DCT coefficients of the diagonal component are scanned in a slanting direction from a horizontal high frequency and vertical high frequency component to a horizontal low frequency and vertical low frequency component, and thus the horizontal high frequency and vertical high frequency component is preferentially encoded.

6. The video coding method according to claim 1, wherein in the coding step, bit-plane VLC (Variable Length Coding) processing is performed on the sub-band component subjected to the DCT processing.

7. The video coding method according to claim 6, wherein in the coding step, a length of scanning is varied corresponding to a bit plane when the bit-plane VLC processing is performed on the sub-band component subjected to the DCT processing.

8. The video coding method according to claim 1, wherein in the coding step, DCT coefficients of the sub-band component subjected to the DCT processing are approximated using a function to encode an error.

9. The video coding method according to claim 1, wherein in the coding step, each of the sub-band components subjected to the DCT processing is multiplexed onto a single stream for each bit plane in encoding the sub-band component subjected to the DCT processing.

10. The video coding method according to claim 9, wherein in the coding step, when each of the sub-band components subjected to the DCT processing is multiplexed onto a single stream for each bit plane, multiplexing is performed preferentially on the horizontal component, the vertical component, and diagonal component, in this order.

11. The video coding method according to claim 1, wherein in the coding method, quantization processing and VLC processing is performed on the sub-band component subjected to the DCT processing.

12. A video decoding method comprising:
a decoding step of decoding a stream of each of the sub-band components generated in the video coding method according to claim 1;
an inverse DCT step of performing inverse DCT processing on the each of the sub-band components decoded; and
a combining step of combining the each of the sub-band components subjected to the inverse DCT processing.

13. The video decoding method according to claim 12, further comprising a selecting step of selecting a stream to decode based on predetermined information,
wherein in the decoding step, the stream selected is decoded.

14. The video decoding method according to claim 12, further comprising a selecting step of selecting an amount of code of a stream to decode based on predetermined information,
wherein in the decoding step, the stream with the amount of code selected is decoded.

15. A video coding apparatus comprising:
an input section that inputs a first-resolution image with a first resolution;
a band dividing section that divides the first-resolution image input into a second-resolution image component with a second resolution lower than the first resolution and each of sub-band components including a horizontal component, a vertical component and a diagonal component;
a DCT section that performs DCT processing on the each of the sub-band components divided; and
a bit-plane VLC section that performs bit-plane VLC processing on the each of the sub-band components subjected to the DCT processing in a respective different scanning order, using a scanning method corresponding to a statistical result of the DCT processing associated with the each of the sub-band components.

16. A video decoding apparatus comprising:
an input section that inputs a stream of each of the sub-band components generated in the video coding apparatus according to claim 15;
a bit-plane VLD section that performs bit-plane VLD (Variable Length-Decoding) processing on the stream of each of the sub-band components input;
an inverse DCT section that performs inverse DCT processing on the each of the sub-band components subjected to the bit-plane VLD processing; and
a combining section that combines the each of the sub-band components subjected to the inverse DCT processing.

17. A video coding apparatus comprising:
an input section that inputs a first-resolution image with a first resolution;
a band dividing section that divides the first-resolution image input into a second-resolution image component with a second resolution lower than the first resolution and each of sub-band components including a horizontal component, a vertical component and a diagonal component;
a DCT section that performs DCT processing on the each of the sub-band component divided;
a quantization section that quantizes the each of the sub-band components subjected to the DCT processing; and
a VLC section that performs VLC processing on the each of the sub-band components quantized using a scanning method corresponding to a statistical result of the DCT processing associated with the each of the sub-band components.

18. A video decoding apparatus comprising:
an input section that inputs a stream of each of the sub-band components generated in the video coding apparatus according to claim 17;
a VLD section that performs VLD processing on the stream of each of the sub-band components input;
a dequantization section that dequantizes the each of the sub-band components subjected to the VLD processing;
an inverse DCT section that performs the inverse DCT processing on the each of the sub-band components dequantized; and
a combining section that combines the each of the sub-band components subjected to the inverse DCT processing.
